(19) United States
(12) Patent Application Publication
(10) Pub. No.: US 2002/0169688 A1
(43) Pub. Date: Nov. 14, 2002

(54) Business model for providing articles and advertisements for pay by contents delivery and related information exchange method and system

(76) Inventor: Kazuhiko Kasai, Kanagawa (JP)

Correspondence Address: William S. Frommer, Esq., FROMMER LAWRENCE & HAUG LLP, 745 Fifth Avenue, New York, NY, 10151, US

(21) Appl. No.: 10/133,255

(22) Filed: Apr. 26, 2002

(30) Foreign Application Priority Data
Apr. 27, 2001 (JP) 2001-132475

(51) Int. Cl. G06F 17/60

(52) U.S. Cl. 705/26

(57) ABSTRACT

A supply side converts, into an information fragment, each of a lot of articles and advertisements provided by publishing sources such as a newspaper company and a plurality of advertisement sources, and codes and delivers the information fragments. The supply side makes a subscription contract including a restricted genre and period with a viewer side via a bidirectional communication medium. The supply side supplies a decoding key that is effective only within the confines of the contract and thereby allows the viewer side to capture and display only information fragments that satisfy the contract. The supply side charges the viewer side for only the captured fragments and collects a fee from the viewer side. Further, on-page advertisement fragments or flier fragments are linked to article fragments so that when an article fragment or an advertisement fragment is captured, the other is also captured and displayed.

### BACKGROUND OF THE INVENTION

1. Field of the Invention

The present invention relates to a business model for providing articles or advertisements for pay by contents delivery and a related information exchange method and system. In particular, the invention relates to a business model for providing, for pay, articles or advertisements on publications and information relating to those via a contents delivering medium, as well as to a related information exchange method and system.

2. Description of the Related Art

Conventionally, services of delivering publications to the homes of subscribers based on subscription contracts are common, an example of which is daily delivery of newspapers. The term “publication” as used herein is defined as such a publication that its contents are updated constantly over time and updated information is supplied to users during subscription periods, and is one of a daily newspaper, a weekly magazine, a magazine that is issued every ten days, a monthly magazine, a quarterly magazine, another kind of periodical, and an irregular publication. Although such publications are provided in such a manner as to be sold copy by copy in stores and on the street, they are generally subscribed during prescribed periods based on contracts. As mentioned above, such publications are delivered to the homes of subscribers during subscription periods.

As for newspapers, for example, each reader makes a subscription contract with a store for a desired newspaper and receives a daily delivery service. Subscribers acquire article information in a state that it is printed on paper.

On the other hand, in general, advertisements are placed on such publications in addition to articles. For example, advertisements (hereinafter referred to as “on-page advertisements”) are placed on each page of a newspaper together with articles. Therefore, when reading articles on each page, a reader also pays attention to advertisements on the page automatically. The effectiveness of each advertisement on a page depends on the probability of attention, which relates to its location on the page.

Further, conventionally, many fliers (handbills) are delivered together with each newspaper.

As described above, conventionally, information of articles and advertisements on publications and information of fliers are mainly supplied to subscribers by a physical means of delivery by using a print medium as typified by paper.

Whereas publications have been supplied in such a manner for a long time, it is wasteful in terms of the use of paper and ink and the spending of time, labor, and cost of delivery. For example, newspapers have a drawback that several hours or more are taken from their printing to delivery to subscribers and hence the contents of articles become out of date, that is, the subscribers cannot obtain latest information. And there are no effective measures for updating the contents quickly.

Further, the conventional manner of providing publications is low in the degree of freedom in setting a subscription period; it is not suitable for short-term subscription or irregular subscription. More specifically, readers are required to make subscription contracts of predetermined, relatively long subscription periods; it is difficult for readers to subscribe publications only during their desired times or periods. Each reader is required to make contracts for respective publications, which is inconvenient.

Articles that are placed on publications belong to a wide variety of genres (fields). The current situation is such that articles that do not belong to genres that are desired by each subscriber are also supplied to him irrespective of his intention. Unnecessary articles are disposed of as waste paper without being read. This means a waste of paper resources and is a factor of cost increase to subscribers.

As in the case of articles, there is no degree of freedom that allows subscribers to specify genres of on-page advertisements. As a result, unnecessary advertisements on publications are disposed of without being read. This means a waste of paper resources and is a factor of cost increase to subscribers.

Further, many fliers (handbills) that are delivered together with each newspaper are disposed of without being read except ones that are necessary to the subscriber. This is not only wasteful but also increases advertisement costs, resulting in a problem of increase of commodity costs. In addition, since there is no degree of freedom that allows subscribers to specify genres of advertisements, time and labor are necessary for subscribers to extract necessary ones of a certain genre from a large number of fliers, which is inconvenient.

In general, advertisements on publications include ones that match the contents of articles on the same publications. In newspapers, for example, if a news article relating to a home tax cut can be associated with an on-page advertisement of a home supplier or a real estate mediation agent, the effectiveness of advertisement and the convenience of subscribers are enhanced. However, in conventional publications, articles and on-page advertisements are associated with each other page by page; it is difficult to associate each article with an arbitrary on-page advertisement or associate each on-page advertisement with one or a plurality of articles. This means a problem that the effectiveness of advertisement is low.

Likewise, there are articles, for example, news articles, that match fliers. For example, where a certain subscriber collects and examines advertisements of real estate objects in Roppongi and its neighborhood to purchase one in that area, it would be very convenient to him if, for example, a news article entitled “Redevelopment of the Roppongi area has been decided” or “A location of the new subway station has been decided in the redevelopment of the Roppongi area” were automatically obtained in association with and simultaneously with an advertisement of a real estate object. However, conventional fliers are not associated with related news articles, which is inconvenient to subscribers.

Conventionally, the contents of each flier are in many cases restricted to a local area and the flier is distributed to only that area. That is, the flier is not distributed to subscribers residing outside the area. This results in a problem that even if a subscriber residing outside a certain area wants to collect information of houses, for example, in the area, he cannot obtain fliers of houses in the area. On the other hand, fliers are distributed to subscribers residing in the area irrespective of whether they need those. Most of the fliers are judged unnecessary and discarded. As such, conventional fliers are not only low in the effectiveness of advertisement but also very wasteful.

Among the information providing services that do not use printed matter as a medium are chargeable news delivery services that use the Internet as a medium. However, even those services have the following problems. Article-by-article contracts are not available. They are disadvantageous in terms of cost because subscribers are obliged to pay line use fees in addition to information charges. Further, they cannot provide a service corresponding to delivery of on-page advertisements and fliers of existing newspapers.

### SUMMARY OF THE INVENTION

The present invention has been made to solve the above various problems in the art, and an object of the invention is therefore to provide a business model for providing articles or advertisements for pay by contents delivery which allow a subscriber to subscribe articles or advertisements of an arbitrary genre during an arbitrary period and to receive information without paying a communication fee, as well as to a related information exchange method and system.

Another object of the invention is to provide an information exchange method and system in which when a subscriber acquires an article of an arbitrary genre, he can automatically acquire an advertisement relating to the article as an attachment, or when a subscriber acquires an advertisement of an arbitrary genre, he can acquire an article relating to the advertisement as an attachment simultaneously with the advertisement.

To attain the above objects, the invention provides a business model for providing articles and advertisements for pay by contents delivery in which articles or contents are delivered to a viewer side over a contents delivery medium and bidirectional information exchange is performed with the viewer side over a communication medium, comprising the steps of converting articles or advertisements into information fragments of various genres, and coding and delivering at least part of the information fragments of each genre; making, with the viewer side, a chargeable provision contract having contract conditions including an arbitrary genre of information fragments to be provided to the viewer side for pay and an arbitrary effective period; and after making the chargeable provision contract, giving the viewer side, via the communication medium, a restrictive reception control signal to be used for decoding only information fragments that satisfy the contract conditions.

According to this business model, since information fragments are provided to the viewer side being carried by a contents delivery stream, the viewer side need not pay for any transmission costs. Since information reaches the viewer side immediately, latest information can be supplied to the user side. Further, constant updating of information can be performed easily. Still further, since the viewer side can freely specify a desired genre, a period, etc. via the communication medium and subscribe desired information contents, the degree of freedom of contract is increased and services providing pronounced economic effects are enabled.

The invention provides an information exchange method using a contents delivery system in which a supply-side information exchange apparatus supplies information contents to a viewer-side information exchange apparatus over a wireless or wired contents delivery medium and information exchange is performed over a bidirectional communication medium that connects the supply-side information exchange apparatus and the viewer-side information exchange apparatus, wherein information contents to be delivered include at least one of article contents and advertisement contents, the information exchange method comprising a first step, executed by the supply-side information exchange apparatus, of drawing up information fragments by adding a mark including genre information indicating a genre to each of the information contents, and broadcasting a contents delivery stream containing the information fragments to the viewer-side information exchange apparatus; a second step, executed by the viewer-side information exchange apparatus, of sending, to the supply-side information exchange apparatus, over the communication medium, order/selection information indicating at least a subscription-desired genre and a subscription period; a third step, executed by the supply-side information exchange apparatus, of sending, to the viewer-side information exchange apparatus, over the communication medium, restrictive reception information to be used for allowing capture of information fragments that satisfy conditions of the order/selection information; a fourth step, executed by settling means of the supply-side information exchange apparatus, of performing processing of charging the viewer-side information exchange apparatus based on the conditions of the order/selection information; and a fifth step, executed by the viewer side information exchange apparatus, of capturing information fragments that satisfy the conditions from the contents delivery stream received in the subscription period based on the restrictive reception information received.

According to this method, since information fragments are sent and received being carried by a contents delivery stream, the viewer side need not pay for any transmission costs. Since information reaches the viewer side immediately, latest information can be supplied to the user side. Further, constant updating of information is enabled. Further, unlike the case of printed publications, paper is not consumed wastefully.

Still further, since the viewer side can freely specify a desired genre, a period, etc. via the communication medium and subscribe desired information contents, the degree of freedom of contract is increased. Further, settlement processing is simplified because it is performed based on order/selection information that is sent over the communication medium.

The invention provides another information exchange method using a contents delivery system in which a supply-side information exchange apparatus supplies information contents to a viewer-side information exchange apparatus over a wireless or wired contents delivery medium and information exchange is performed over a bidirectional communication medium that connects the supply-side information exchange apparatus and the viewer-side information exchange apparatus, wherein information contents to be delivered include at least one of article contents and advertisement contents, the information exchange method comprising a first step, executed by the supply-side information exchange apparatus, of drawing up information fragments by adding a mark including genre information indicating a genre to each of the information contents, generating article/advertisement correspondence information that correlates information fragments of the article contents with information fragments of the advertisement contents, and broadcasting a contents delivery stream containing the information fragments and the article/advertisement correspondence information to the viewer-side information exchange apparatus; a second step, executed by the viewer-side information exchange apparatus, of sending, to the supply-side information exchange apparatus, over the communication medium, order/selection information indicating at least a subscription-desired genre and a subscription period; a third step, executed by the supply-side information exchange apparatus, of sending, to the viewer-side information exchange apparatus, over the communication medium, restrictive reception information to be used for allowing capture of information fragments that satisfy conditions of the order/selection information; a fourth step, executed by settling means of the supply-side information exchange apparatus, of performing processing of charging the viewer-side information exchange apparatus based on the conditions of the order/selection information; and a fifth step, executed by the viewer side information exchange apparatus, of capturing information fragments that satisfy the conditions and information fragments that are correlated with the information fragments that satisfy the conditions by the article/advertisement correspondence information from the contents delivery stream received in the subscription period based on the restrictive reception information received.

In this method, in the fifth step, at the same time as an information fragment of an article content is selected and captured based on received restriction reception information, an information fragment of an advertisement content that is correlated with the former information fragment in advance is captured based on received article/advertisement correspondence information, or vice versa. This not only facilitates correlating articles with advertisements on an article basis or an advertisement basis, but also enables simultaneous display of an article and an advertisement corresponding to it or an advertisement and an article corresponding to it. Since not only information fragments but also article/advertisement correspondence information is received from a contents delivery stream, the viewer side need not pay for any transmission costs and processing to be performed after reception is made easier.

Further, when the correspondence between articles and advertisement needs to be altered, the only measure to be taken is to alter the contents of article/advertisement correspondence information at the first step. The correspondence between articles and advertisement can be altered in a flexible manner.

Each of the above information exchange methods may be such that the first step sends the contents delivery stream to the viewer-side information exchange apparatus after coding at least the information fragments; the third step causes the restrictive reception information to include decoding information to be used for decoding at least coded information fragments; and the fifth step decodes captured coded information fragments based on the decoding information received. In this case, a content delivery stream whose safety is secured by coding and decoding can be received in a restricted manner.

Each of the above information exchange methods may be such that the third step causes the restrictive reception information to include control information to be used for causing the viewer-side information exchange apparatus to capture only information fragments that satisfy the conditions or only the information fragments that satisfy the conditions and information fragments that are correlated with the information fragments that satisfy the conditions in the subscription period; and the fifth step captures only information fragments that satisfy the conditions or only the information fragments that satisfy the conditions and information fragments that are correlated with the information fragments that satisfy the conditions from the contents delivery stream in the subscription period based on the control information received. In this case, a content delivery stream whose safety is secured by a simplified mechanism that does not employ coding and decoding can be received in a restricted manner. In particular, only articles and advertisements correlated with those can be received.

The invention provides an information exchange system in which a supply-side information exchange apparatus supplies information contents to a viewer-side information exchange apparatus over a wireless or wired contents delivery medium and information exchange is performed over a bidirectional communication medium that connects the supply-side information exchange apparatus and the viewer-side information exchange apparatus, wherein information contents to be delivered include at least one of article contents and advertisement contents; and wherein the supply-side information exchange apparatus comprises drawing-up means for drawing up information fragments by adding a mark including genre information indicating a genre to each of the information contents; delivering means for delivering a contents delivery stream containing the information fragments to the viewer-side information exchange apparatus; supply-side sending and receiving means for receiving, via the communication medium, order information indicating subscription conditions that is sent from the viewer-side information exchange apparatus, and for sending, to the viewer-side information exchange apparatus, over the communication medium, restrictive reception information to be used for allowing capture of information fragments that conform to the order information; and settling means for performing processing of charging the viewer-side information exchange apparatus based on the subscription conditions; and the viewer-side information exchange apparatus comprises viewer-side sending and receiving means for sending the order information indicating, as the subscription conditions, at least a subscription-desired genre and a subscription period to the supply-side information exchange apparatus over the communication medium, and for receiving the restrictive reception information from the supply-side information exchange apparatus via the communication medium; and information fragments receiving means for capturing information fragments that satisfy the subscription conditions from the contents delivery stream received in the subscription period based on the received restrictive reception information.

According to this system, since information fragments are sent and received being carried by a contents delivery stream, the viewer side need not pay for any transmission costs. Since information reaches the viewer side immediately, latest information can be supplied to the viewer side. Unlike the case of printed publications, paper is not consumed wastefully. Further, constant updating of information in the viewer side is enabled.

Still further, since the viewer side can freely specify a desired genre, a period, etc. via the communication medium and subscribe desired information contents, the degree of freedom of contract is increased. Further, settlement processing is simplified because it is performed based on subscription conditions that are sent over the communication medium.

The invention provides another information exchange system in which a supply-side information exchange apparatus supplies information contents to a viewer-side information exchange apparatus over a wireless or wired contents delivery medium and information exchange is performed over a bidirectional communication medium that connects the supply-side information exchange apparatus and the viewer-side information exchange apparatus, wherein information contents to be delivered include at least one of article contents and advertisement contents; and wherein the supply-side information exchange apparatus comprises: drawing-up means for drawing up information fragments by adding a mark including genre information indicating a genre to each of the information contents; article/advertisement correlating means for generating article/advertisement correspondence information that correlates information fragments of the article contents with information fragments of the advertisement contents; delivering means for delivering a contents delivery stream containing the information fragments and the article/advertisement correspondence information to the viewer-side information exchange apparatus; supply-side sending and receiving means for receiving, via the communication medium, order information indicating subscription conditions that is sent from the viewer-side information exchange apparatus, and for sending, to the viewer-side information exchange apparatus, over the communication medium, restrictive reception information to be used for allowing capture of information fragments that conform to the order information; and settling means for performing processing of charging the viewer-side information exchange apparatus based on the subscription conditions; and the viewer-side information exchange apparatus comprises receiving means for receiving the contents delivery stream containing the information fragments and the article/advertisement correspondence information; viewer-side sending and receiving means for sending the order information indicating, as the subscription conditions, at least a subscription-desired genre and a subscription period to the supply-side information exchange apparatus over the communication medium, and for receiving the restrictive reception information from the supply-side information exchange apparatus via the communication medium; and information fragments receiving means for capturing information fragments that satisfy the subscription conditions and information fragments that are correlated with the information fragments that satisfy the subscription conditions by the article/advertisement correspondence information from the received contents delivery stream in the subscription period based on the received restrictive reception information and article/advertisement correspondence information.

In this system, in the viewer-side information exchange apparatus, article/advertisement correspondence information is received from a contents delivery stream and restrictive reception information is received via the communication medium. At the same time as an information fragment of an article that conform to the restriction reception information is captured, an information fragment of an advertisement that is correlated with the former information fragment in advance by the article/advertisement correspondence information is captured, or vice versa. This enables simultaneous display of an article and an advertisement corresponding to it or an advertisement and an article corresponding to it. Since not only information fragments but also article/advertisement correspondence information is transmitted by contents delivery, the viewer side need not pay for any transmission costs.

Further, when the correspondence between articles and advertisement needs to be altered, the only measure to be taken is to alter the contents of article/advertisement correspondence information. The correspondence between articles and advertisement can be altered in a flexible manner.

Each of the above information exchange systems may be such that the delivering means sends the contents delivery stream to the viewer-side information exchange apparatus after coding at least the information fragments; the supply-side sending and receiving means causes the restrictive reception information to include decoding information to be used for decoding at least coded information fragments; and the information fragments receiving means decodes captured coded information fragments based on the decoding information received. In this case, a content delivery stream whose safety is secured by coding and decoding can be received in a restricted manner.

Each of the above information exchange system may be such that the supply-side sending and receiving means causes the restrictive reception information to include control information to be used for causing the information fragments receiving means to capture only information fragments that satisfy the subscription conditions or only the information fragments that satisfy the subscription conditions and information fragments that are correlated with the information fragments that satisfy the subscription conditions in the subscription period; and the information fragments receiving means captures only information fragments that satisfy the subscription conditions or only the information fragments that satisfy the subscription conditions and information fragments that are correlated with the information fragments that satisfy the subscription conditions from the contents delivery stream in the subscription period based on the control information received. In this case, a content delivery stream whose safety is secured by a simplified mechanism that does not employ coding and decoding can be received in a restricted manner. In particular, restrictive reception of only articles and advertisements correlated with those is realized.

### BRIEF DESCRIPTION OF THE DRAWINGS

FIG. 1 outlines the configuration of an information exchange system (first embodiment) to which an information exchange method according to the present invention is applied;

FIG. 2 is a block diagram outlining a supply side shown in FIG. 1;

FIG. 3 is a block diagram outlining a viewer side shown in FIG. 1;

FIG. 4 illustrates a flow of information in the information exchange system of FIG. 1;

FIG. 5 is a flowchart showing the operation of the information exchange system of FIG. 1;

FIG. 6 shows exemplary display pictures in the viewer side;

FIG. 7 shows an exemplary genre list;

FIG. 8 is a block diagram outlining a supply side that is different from the one shown in FIG. 2;

FIG. 9 is a block diagram showing a detailed configuration of the supply side of FIG. 8;

FIG. 10 is a block diagram showing a detailed configuration of the viewer side of FIG. 3;

FIG. 11 is a communication sequence chart of an information exchange system including the supply side of FIG. 8;

FIGS. 12 and 13 are block diagrams showing the configurations of a supply side and a viewer side, respectively, of another information exchange system (second embodiment) to which another information exchange method according to the invention is applied;

FIG. 14 illustrates an information exchange system in which the supply side consists of a plurality of master parties;

FIG. 15 outlines the configuration of another information exchange system (third embodiment) to which another information exchange method according to the invention is applied;

FIG. 16 outlines the configuration of another information exchange system (fourth embodiment) to which another information exchange method according to the invention is applied;

FIG. 17 outlines the configuration of another information exchange system (fifth embodiment) to which another information exchange method according to the invention is applied;

FIG. 18 shows an exemplary correspondence table that correlates article fragments with advertisement fragments;

FIGS. 19 and 20 are block diagrams showing the configurations of a supply side and a viewer side, respectively, of the information exchange system of FIG. 17;

FIG. 21 shows exemplary pictures displayed in the viewer side of FIG. 20;

FIG. 22 shows a business model of still another information exchange system (sixth embodiment) to which another information exchange method according to the invention is applied;

FIG. 23 shows a business model of yet another information exchange system (seventh embodiment) to which another information exchange method according to the invention is applied; and

FIG. 24 shows a business model of a further information exchange system (eighth embodiment) to which another information exchange method according to the invention is applied.

### DESCRIPTION OF THE PREFERRED EMBODIMENTS

Preferred embodiments of the present invention will be hereinafter described in detail with reference to the accompanying drawings. The following embodiments are just part of preferred examples showing the essential configurations and functions of the invention, and hence may include various limitations that are technically preferable. However, the scope of the invention is not restricted to those limitations unless otherwise stated in the following description.

Although in each of the following embodiments the contents delivery medium is a digital broadcasting medium as a typical example, the contents delivery medium to which the invention is applied is not limited to a digital broadcasting medium and naturally covers media in a broad range that deliver digital contents.

Further, although in each of the following embodiments the contents delivery is data broadcast as a typical example, the contents delivery to which the invention is applied is not limited to data broadcast and naturally covers means in a broad range that deliver digital contents.

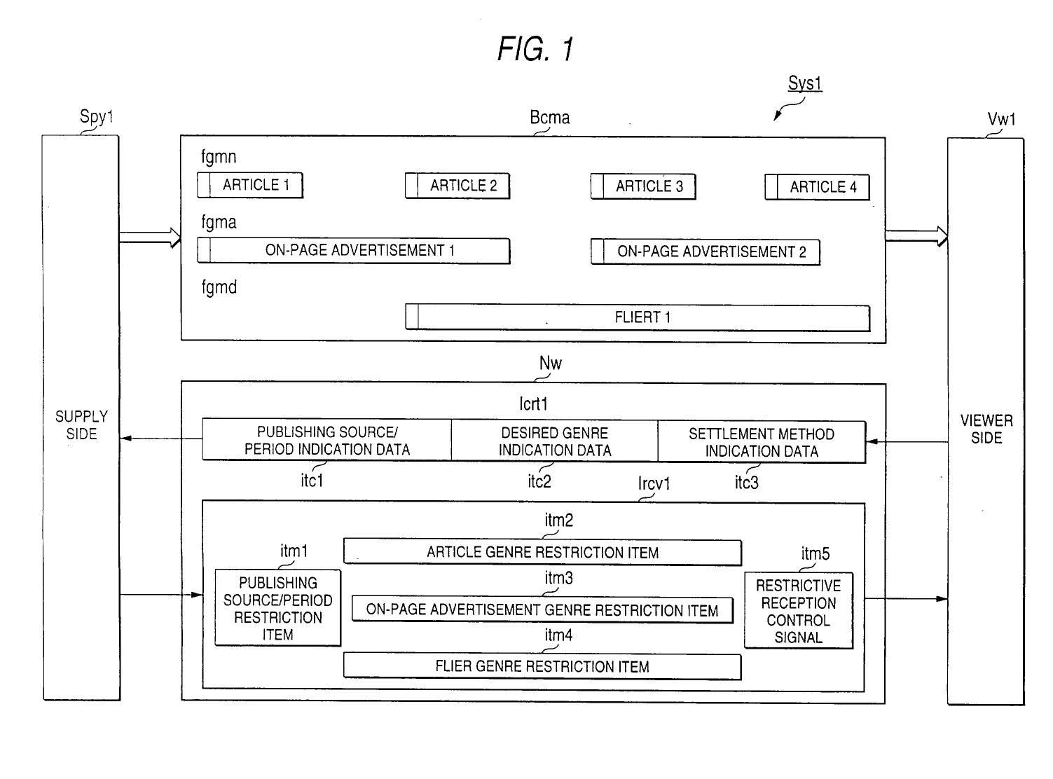

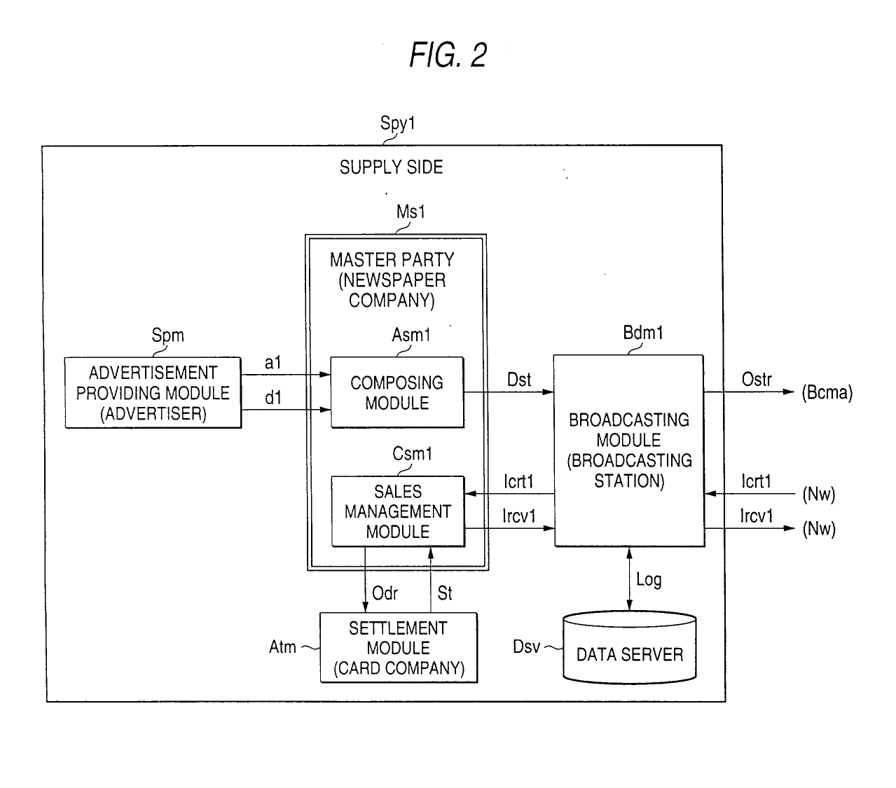

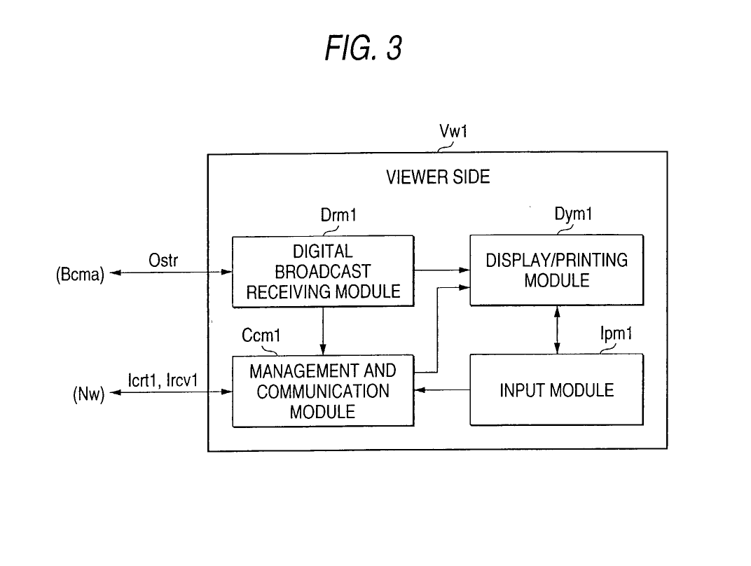

FIG. 1 outlines the configuration of an information exchange system (first embodiment) Sys1 to which an information exchange method according to the invention is applied. FIG. 2 is a block diagram outlining a supply side Spy1 shown in FIG. 1. FIG. 3 is a block diagram outlining a viewer side Vw1 shown in FIG. 1. The configuration will be outlined below with reference to FIGS. 1-3.

The information exchange system Sys1 is equipped with the supply side Spy1, the viewer side Vw1, and a broadcasting medium Bcma and a communication medium Nw for mediating information exchange between the supply side Spy1 and the viewer side Vw1.

The supply side Spy1 draws up information fragments of chargeable information contents (e.g., newspaper articles and chargeable advertisements) and broadcasts those in the form of a data broadcast stream consisting of a plurality of information fragments via the digital broadcasting medium Bcma by its own digital broadcasting function. Further, the supply side Spy1 receives order/selection information Icrt1 from the viewer side Vw1 by a bidirectional communication function using the communication medium Nw and establishes a contract relating to chargeable information provision. Further, the supply side Spy1 sends, to the viewer side Vw1, via the communication medium Nw, restrictive reception information Ircv1 to be used for capturing only information fragments as subjects of chargeable information provision from a data broadcast stream. Still further, the supply side Spy1 collects, from the viewer side Vw1, a charge for chargeable information provision according to the contract.

The viewer side Vw1 generates order/selection information Icrt1 in which desired subscription conditions and sends it to the supply side Spy1 via the communication medium Nw, and thereby makes a contract relating to chargeable information provision. When receiving, via the communication medium Nw, a restrictive reception information Ircv1 that reflects the subscription conditions, the viewer side Vw1 captures only capture-permitted information fragments from a data broadcast stream based on the contents of the restrictive reception information Ircv1. The viewer side Vw1 can display on the screen, store, or print out the captured information fragments.

To perform the above functions, the supply side Spy1 is equipped with supply-side information exchange apparatuses. Each of the supply-side information exchange apparatuses is a computer system that is a mainframe computer, a workstation, a combination of a server and personal computers. These systems and devices may be a plurality of computers that are connected to each other via an intranet or a LAN, or the above systems and devices are physically incorporated in a single computer to provide a multi-platform environment as a whole. Each of the supply-side information exchange apparatuses have components of a processor (CPU), memories such as a RAM and a ROM, an input/output interface, a bus, etc. (not shown). However, they are general components of a computer system and hence will not be described to eliminate undue redundancy and complexity.

To perform the above functions, the viewer side Vw1 is equipped with a viewer-side information exchange apparatus, which is receiver having a digital broadcast receiving function and a bidirectional communication function, a set-top box (STB), or the like. In any case, the viewer-side information exchange apparatus is implemented as a computer function using digital equipment. Since its components are general ones as used in a computer system, they will not be described to eliminate undue redundancy and complexity.

A BS/110°-CS digital broadcast bidirectional receiver as an example of the viewer-side information exchange apparatus incorporates a broadcast wave receiving section and a bidirectional communication section that is connectable to a communication line. Data that are carried by broadcast waves are prepared according to MPEG2-TS, and the bidirectional communication protocol complies with, for example, TCP/IP that is common in the Internet. The contents description language is HTML, XML, a language that is based on BML that was developed for the BS digital broadcast, or a like language.

The digital broadcasting medium Bcma may be any of broadcasting satellite (BS) digital broadcast waves, a communications satellite (CS) digital broadcast waves, digital ground broadcast waves, and a CATV bidirectional digital broadcast path.

The communication medium Nw may be any of direct connection type communication and communication between two points according to the point-to-point configuration using public telephone lines or a dedicated telephone line and packet network communication an example of which is the Internet.

In the satellite digital broadcast and the ground-wave digital broadcast, an on-air stream Ostr consisting of a program broadcast stream that carries a TV program content and a data broadcast stream that carries a data broadcast content is sent from the supply side Spy1 being carried by the digital broadcasting medium Bcma that is a unidirectional (i.e., the downstream direction from the supply side Spy1 to the viewer side Vw1) transmitting means. In particular, where the ground-wave digital broadcast, which is suitable for local broadcast, complies with the OFDM (orthogonal frequency division multiplexing) standard, a plurality of on-air streams can be allocated to the same frequency band. Further, ground communication lines such as public telephone lines are used as a bidirectional access network between the supply side Spy1 and the viewer side Vw1. In the digital CATV broadcast, transmission of a TV program stream and a data broadcast stream and a bidirectional communication between the supply side Spy1 and the viewer side Vw1 are performed over a wide-band cable.

As described above, the information exchange system Sys1 according to the invention is a hybrid information exchange system using both of the unidirectional broadcast path (digital broadcasting medium Bcma) and the bidirectional communication path (communication medium Nw).

In the case of a station that is dedicated to data broadcast, irrespective of whether it is satellite digital broadcast, ground-wave digital broadcast, or digital CATV broadcast, a data broadcast stream carrying a data broadcast content is sent and received unidirectionally. In addition, bidirectional communication paths between the broadcasting station and viewers are provided.

The information fragment is a unit of chargeable information contents that are individual articles, on-page advertisements, and fliers that constitute a publication. For example, in the case of a newspaper as a publication, each of articles etc. constituting its pages corresponds to an information fragment. To simplify the description, in the following the term “information fragment” may be abbreviated as “fragment.”

The information fragment is classified into the following:

(1) an article fragment fgmn (an article itself; may include a photograph, chart, table, or the like)

(2) an advertisement-placed-on-page fragment fgma (abbreviated as “on-page advertisement fragment”)

(3) a flier fragment fgmd

Each of the information fragments fgmn, fgma, and fgmd consists of a content main body and a header that is located before the head of the content main body. The header contains such information as a publishing source (a code of a newspaper name or a magazine name) of the information fragment, a type and a genre, and an identification number. The viewer side Vw1 can make a subscription contract and be charged on an information fragment basis. During broadcast, a plurality of information fragments are combined into a packet and a data broadcast stream consisting of a plurality of packets and a TV program broadcast stream are combined into an on-air stream Ostr.

Article fragments fgmn are provided for pay. On-page advertisement fragments fgma and flier fragments fgmd are delivered to the viewer Vw1 free of charge or provided as chargeable advertisements depending on their contents.

The order/selection information Icrt1 consists of a subscription-desired publishing source (a newspaper name or a magazine name), data itc1 indicating a desired subscription period, data itc2 indicating a desired genre of articles or advertisements, and data itc3 (e.g., a card number) indicating a settlement method such as charge payment by a credit card. Using the order/selection information Icrt1, the viewer side Vw1 can set desired subscription conditions and send those to the supply side Spy1 over the communication medium Nw.

The restrictive reception information Ircv1 is generated when the supply side Spy1 and the viewer side Vw1 have made a subscription contract with each other based on a transmitted order/selection information Icrt1. The restrictive reception information Ircv1 consists of item itm1 for restriction to a particular publishing source and period, item itm2 for restriction to a particular article genre, an item itm3 for restriction to a particular on-page advertisement genre, item itm4 for restriction to a particular flier genre, and a restrictive reception control signal itm5. Using the restrictive reception information Ircv1, the supply side Spy1 can gives, to the viewer side Vw1, via the communication medium Nw, information fragments that the viewer side Vw1 can capture and a signal that enables capture of information fragments.

The restrictive reception control signal itm5 is a decoding key that is used in a system in which information fragments are broadcast after being coded, or a control signal for controlling activation and stopping of a receiving circuit etc. that is used in a system in which information fragments are not coded. The decoding key is prepared for each of articles, on-page advertisements, and fliers and for each genre.

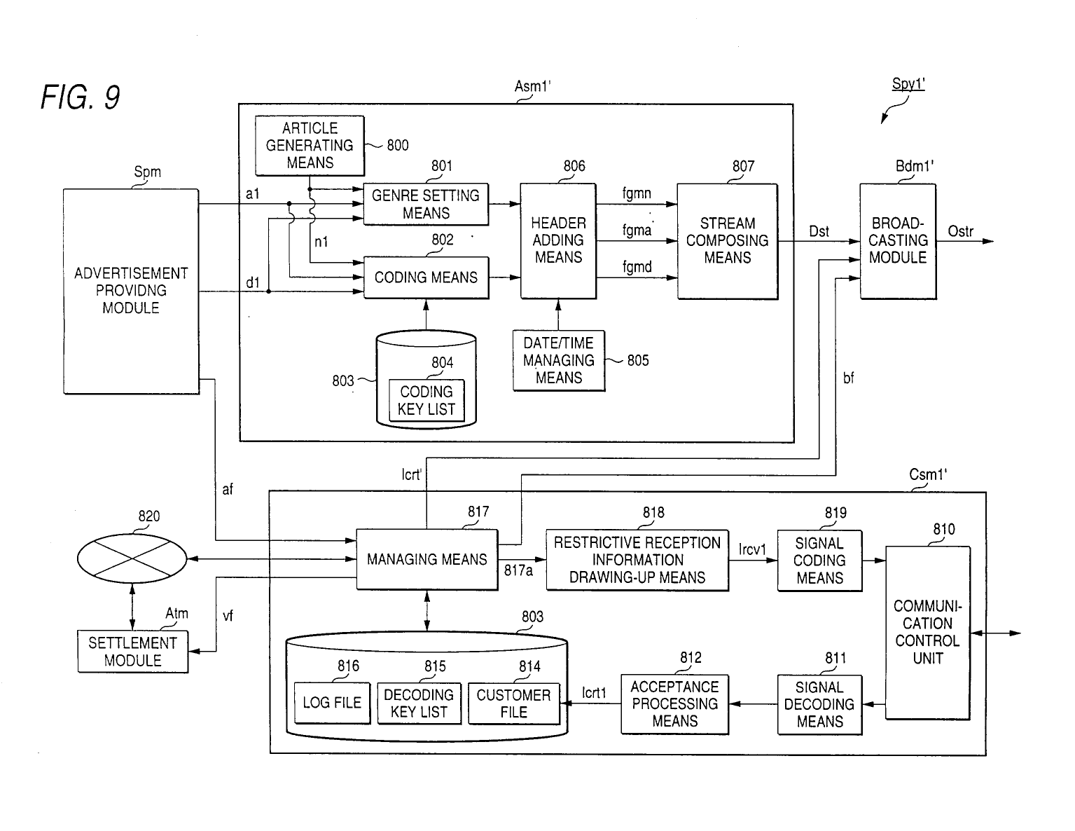

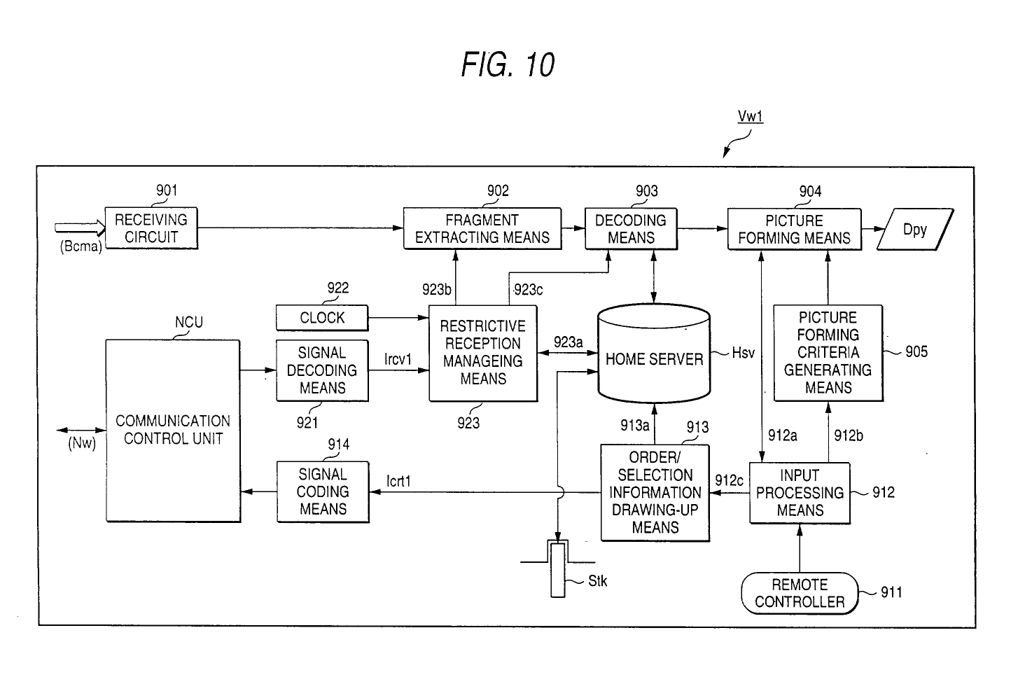

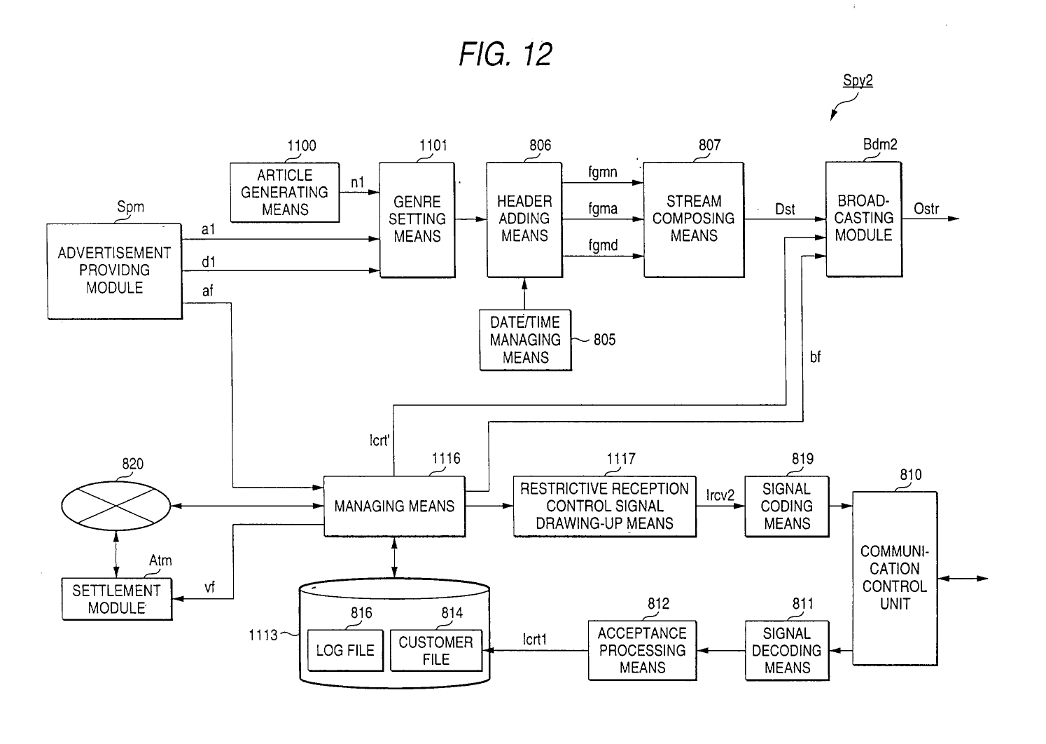

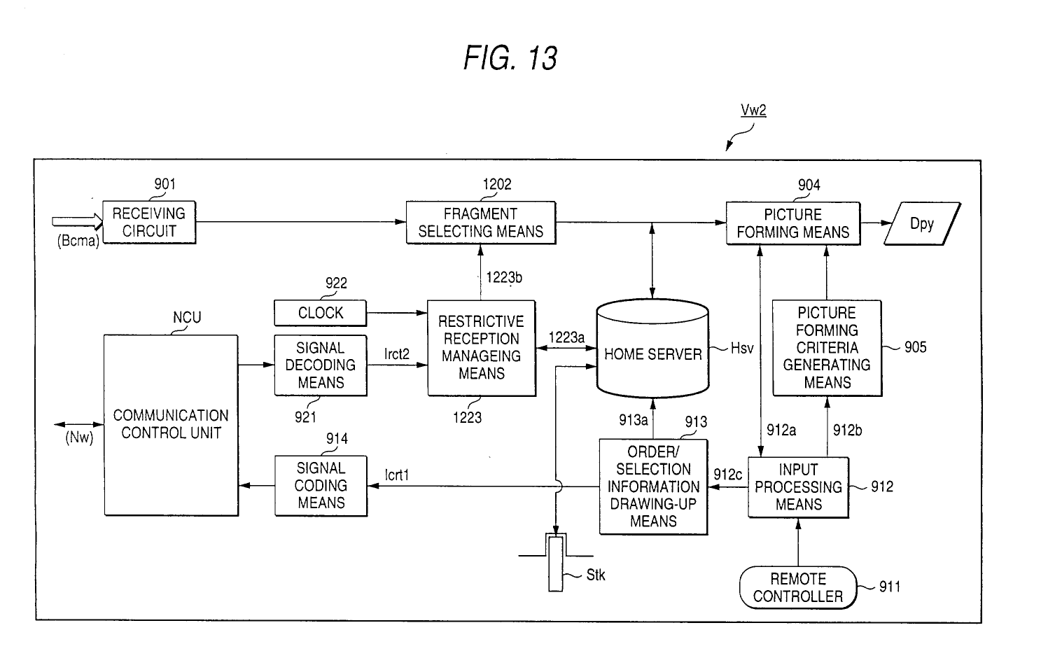

A configuration of the former case using the decoding key will be described later with reference to FIGS. 9 and 10. A configuration of the latter case using the control signal will be described later with reference to FIGS. 12 and 13.

As shown in FIG. 2, the supply side Spy1 is equipped with a composing module Asm1, a sales management module Csm1, a broadcasting module Bdm1, a settlement module Atm, and an advertisement providing module Spm. The composing module Asm1 and the sales management module Csm1 constitute a master party Ms1 of the chargeable information providing business. In this embodiment, the master party Ms1 is a newspaper company or a publishing company. The advertisement providing module Spm corresponds to an advertiser, that is, a sponsor company. The settlement module Atm corresponds to a credit card company. The broadcasting module Bdm1 corresponds to a broadcasting station.

The composing module Asm1 codes, if necessary, by using a coding key, the body of an article (e.g., a news article generated by the newspaper company) that has been generated by the master party Ms1 by gathering material by itself, and draws up an article fragment fgmn by adding a header to the (coded) body of the article. Also, the composing module Asm1 codes advertisement data a1 and/or d1 that are received from the advertisement providing module Spm, and draws up an on-page advertisement fragment fgma and/or a flier fragment fgmd by adding a header to the coded advertisement data. The composing module Asm1 draws up a data stream Dst consisting of the above information fragments having the headers, and supplies it to the broadcasting module Bdm1.

The broadcasting module Bdm1 converts the data stream Dst into a data broadcast stream, scrambles it together with a program broadcast stream having a TV program as a content to generate an on-air stream Ostr, and broadcasts it digitally by causing it to be carried by the digital broadcasting medium Bcma. In this manner, the data broadcast stream is broadcast being filled with information fragments of various genres that have been issued by the newspaper company. As such, the data broadcast stream contains all fragments. Each of an indefinite number of viewer sides Vw1 selects from the received data broadcast stream and captures only fragments that conform to its own subscription contract.

On the other hand, the broadcasting module Bdm1 (broadcasting station) receives an order/selection information Icrt1 that has been transmitted from the viewer side Vw1 (not shown) over the communication medium Nw and transfers it to the sales management module Csm1. The broadcasting module Bdm1 records it in a data server Dsv as log data Log like monitoring it. The broadcast station records log data Log to recognize and check a subscription contract that is made between the master party Ms1 and the viewer Vw1. The log data Log serve as a basis of calculation of a reward that the broadcasting station is to receive from the master party Ms1 in accordance with a subscription fee of the contract.

Upon establishing a contract based on the transferred order/selection information Icrt1, the sales management module Csm1 generates a restrictive reception information Ircv1 and sends it to the viewer side Vw1 via the broadcasting module Bdm1. Therefore, the viewer side Vw1 can recognize the establishment of the subscription contract by arrival of the restrictive reception information Ircv1.

Further, for settlement processing, the sales management module Csm1 sends order data Odr containing a card number or an account number of the viewer side Vw1 to the settlement module Atm. the sales management module Csm1 receives settlement data St from the settlement module Atm.

The settlement module Atm performs settlement by, for example, charging the subscription fee of the contract to a bank account of the viewer side Vw1 based on the received order data Odr. Upon completion of the payment processing, the settlement module Atm sends settlement data St to the sales management module Csm1.

As shown in FIG. 3, the viewer side Vw1 is equipped with a digital broadcast receiving module Drm1 having a receiving function for the digital broadcasting medium Bcma, a display/printing module Dym1, and input module Imp1, and a management and communication module Ccm1 having a function of performing bidirectional communication via the communication medium Nw.

If the digital broadcasting medium Bcma is radio waves, for example, the digital broadcast receiving module Drm1 has an antenna circuit etc. When receiving an on-air stream Ostr, the digital broadcasting medium Bcma descrambles it, captures, from a data broadcast stream, information fragments that conform to restrictive reception instructions that are given by the management/communication module Ccm1, and stores those in a home server of the digital broadcasting medium Bcma or supplies those to the display/printing module Dym1 after decoding those. Receiving the information fragments, the display/printing module Dym1 forms a screen image according to a screen display format and causes its own display device to display the image, or causes a printer or the like to print the information fragments.

In doing so, the display/printing module Dym1 exchanges signals with the input module Imp1. Based on a control signal given by the input module Imp1, the display/printing module Dym1 changes the display picture formation, switches between real-time display and display by reproducing information supplied from the home server, and switches between screen display and printing. The display/printing module Dym1 displays or prints information relating to restrictive reception and other information based on data that are given by the management and communication module Ccm1.

Equipped with a user-manipulable device such as a remote controller, the input module Imp1 makes instructions relating to the display picture formation, selects an item on a displayed picture, makes instructions relating to screen display or printing, and sends, to the management and communication module Ccm1, an order relating to a subscription contract and instructions relating to subscription conditions. Based on the received order relating to a subscription contract and instructions relating to subscription conditions, the management and communication module Ccm1 generates order/selection information Icrt1 and sends it to the supply side Spy1 over the communication medium Nw. Further, the management and communication module Ccm1 receives a restrictive reception information Ircv1 and gives restrictive reception instructions to the digital broadcast receiving module Drm1. Still further, the management and communication module Ccm1 gives the display/printing module Dym1 information that enables selection and checks on the screen.

The above-described operations will be summarized below. The supply side Spy1 codes contents data, adds headers to those, and broadcasts resulting coded fragments having headers as a data broadcast stream. The viewer side Vw1 generates order/selection information Icrt1 and sends it to the supply side Spy1 over the communication medium Nw. The supply side Spy1 establishes a subscription contract and sends restrictive reception information Ircv1 to the viewer side Vw1 over the communication medium Nw. The viewer side Vw1 reads the information of the headers of coded fragments that have been received as a data broadcast stream, decodes using a decoding key and captures only fragments that conform to the contract based on the restrictive reception information Ircv1, and displays or prints those. In this manner, articles and advertisements are supplied to the viewer for pay.

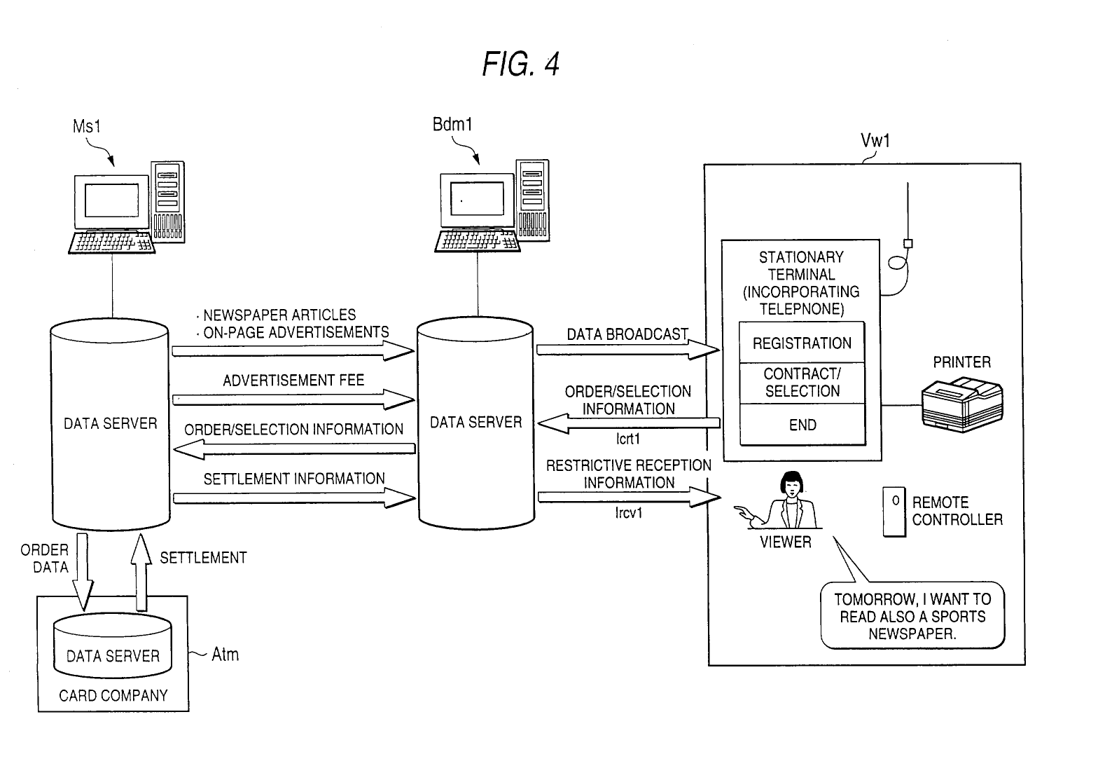

FIGS. 4-6 illustrate the information exchange method (first embodiment) according to the invention.

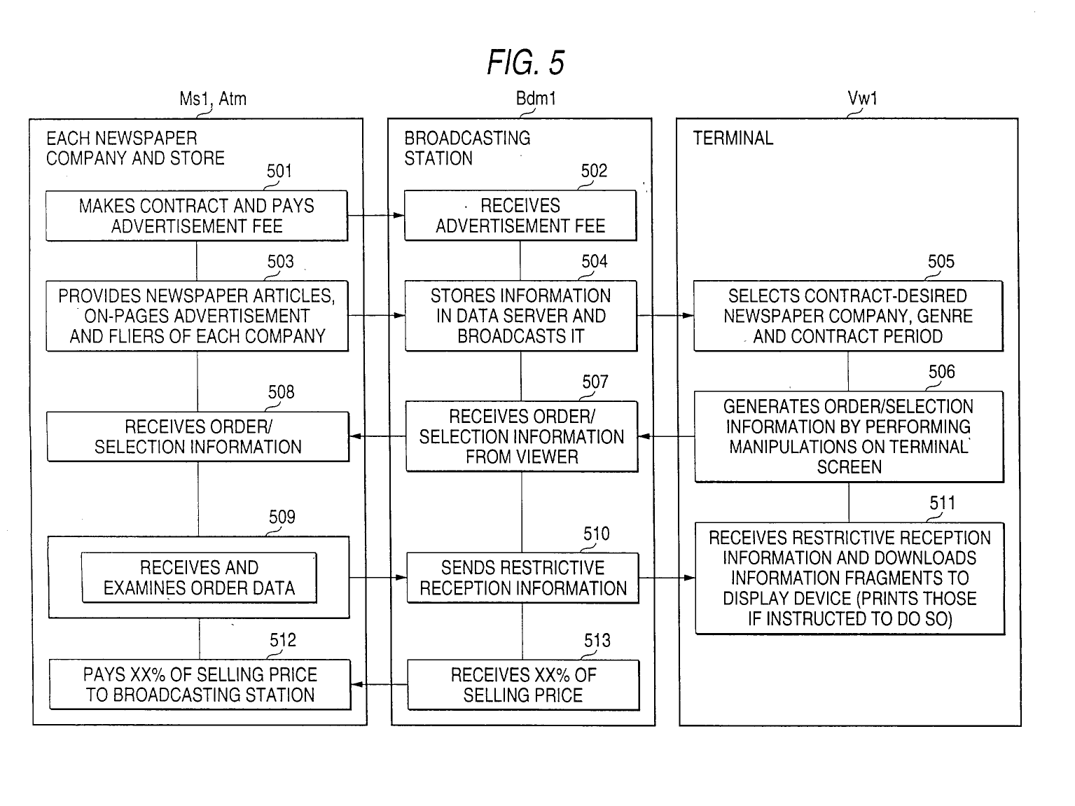

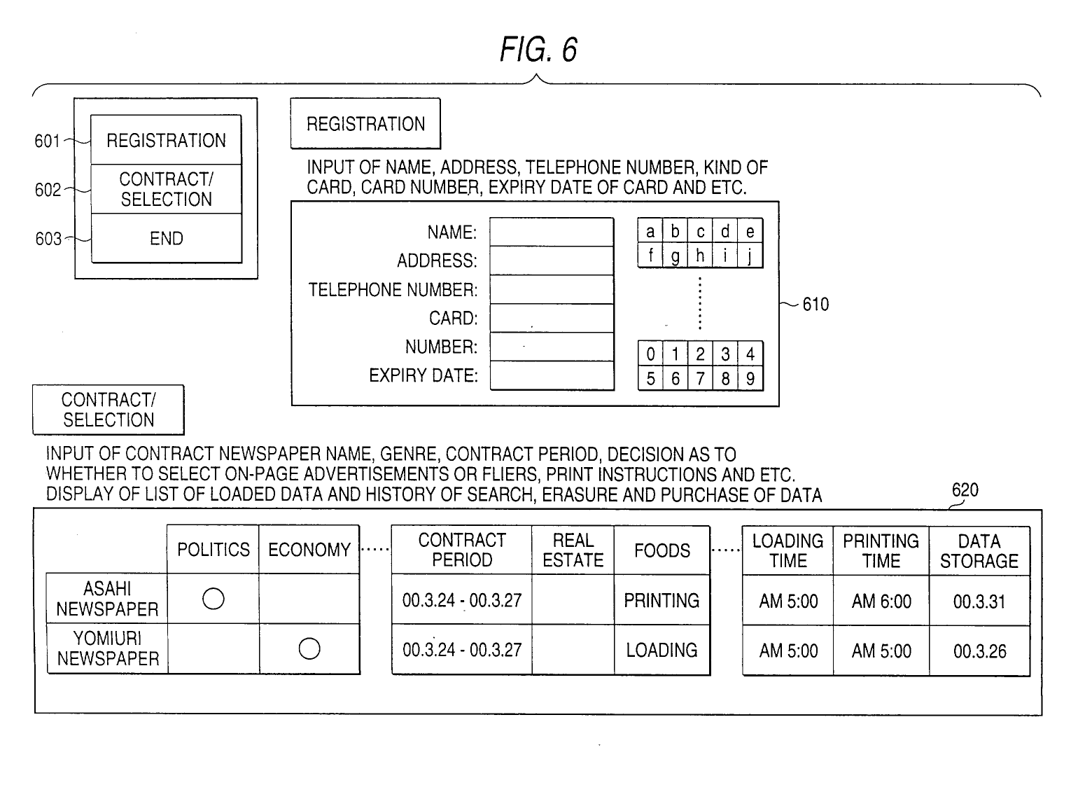

FIG. 4 illustrates a flow of information in the information exchange system Sys1 of FIG. 1. FIG. 5 is a flowchart showing the operation of the information exchange system Sys1. FIG. 6 shows exemplary display pictures in the viewer side Vw1. In this embodiment, in the supply side Spy1, the master party Ms1 is a newspaper company, the settlement processing module Atm is a credit card company, and the broadcasting module Bdm1 is a broadcasting station. A description will now be made by referring to FIGS. 4 and 5 contrastively as well as referring to FIG. 6 and the corresponding parts of FIG. 1 when necessary.

At step 501, the master party Ms1 makes a contract with the broadcasting module Bdm1 (broadcasting station) and pays an advertisement fee (radio waves use fee) to the broadcasting module Bdm1. At step 502, the broadcasting module Bdm1 receives the advertisement fee. At step 503, the master party Ms1 draws up information fragments by adding a mark (header) containing at least genre information to each of information contents (newspaper articles, on-page advertisements, and fliers) and sends a sequence of information fragments to the broadcasting module Bdm1 by using a data server (see FIG. 4) of the master party Ms1 like a buffer. At step 504, the broadcasting module Bdm1 stores the information fragments in its own data server (see FIG. 4), draws up a data broadcast stream containing the information fragments, and broadcasts it to the information exchange apparatus of the viewer side Vw1. During the execution of the above steps, the advertisement providing module Spm (advertiser) pays an advertisement fee to the master party Ms1.

At step 505 the information exchange apparatus (in FIG. 4, a stationary terminal in the viewer's home) of the viewer side Vw1 causes the user to select a subscription-desired newspaper company, a genre, and a contract subscription period. This is done by the user's performing selection manipulations on a picture as shown in FIG. 6, whereupon order/selection information is generated in a specified manner.

A registration frame 601, a contract/selection frame 602, an end frame 603 are displayed on the screen of the terminal. If the registration frame 601 is selected first, a picture 610 is displayed. The user is registered if he inputs, on the picture 610, his name, address, and telephone number, and a kind, number, and expiry date of a card. If the contract/selection frame 602 is selected after completion of the registration, a picture 620 is displayed. The user inputs, on the picture 620, desired subscription conditions such as a newspaper name, a genre, a contract period, a decision as to whether to select on-page advertisements or fliers, and print instructions. A list of loaded data, a history of search, erasure, and purchase of data, and other information are shown in the picture 620. If the user selects the end frame 603 after completion of contract/selection manipulations, the stationary terminal generates order/selection information Icrt1 based on the thus-input data and sends it to the broadcasting module Bdm1 over the communication medium Nw (step 506).

At step 507, the broadcasting module Bdm1 receives the order/selection information Icrt1 from the viewer side Vw1 and stored log data in the station-side data server and, immediately thereafter, sends the order/selection information Icrt1 to the master party Ms1. At step 508, receiving the order/selection information Icrt1, the master party Ms1 sends order data to the settlement module Atm. At step 509, the settlement module Atm examines the order data, performs settlement processing, and communicates a result to the master party Ms1. At step 510, the master party Ms1 draws up restriction reception information Ircv1 that permits capture of information fragments that conform to the details specified by the order/selection information Icrt1, and sends it to the viewer side Vw1 via the broadcasting module Bdm1 and the communication medium Nw.

At step 511, based on the received restriction reception information Ircv1, the viewer side Vw1 captures information fragments that conform to the specified details from a received data broadcast stream during the specified period. The received restriction reception information Ircv1 and the captured contents are displayed, printed by the printer, or stored in the home server.

At step 512, the master party Ms1 pays, to the broadcasting module Bdm1, a reward (kickback) that is a prescribed percentage of the amount of money of the established contract. The broadcasting module Bdm1 receives it at step 513. At this time, the broadcasting module Bdm1 can check, based on the deal information (log data) stored in the data server, whether the reward is correct.

As described above, a business of providing publications for pay using data broadcast and a network is realized by using the information exchange method according to the invention.

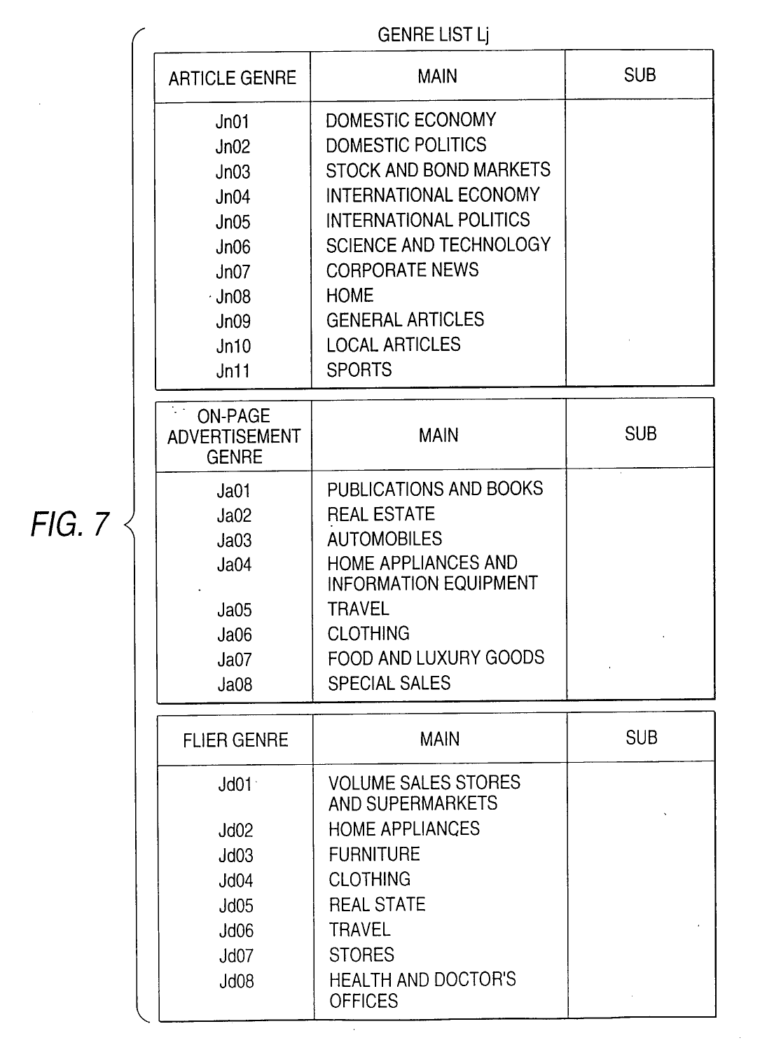

As described above, the master party Ms1 draws up an information fragment by adding a header containing genre information to each information content (newspaper article, on-page advertisement, or flier). FIG. 7 shows an exemplary genre list Lj that is referred to during that course.

As shown in FIG. 7, article genres Jnxx are domestic economy, domestic politics, stock and bond markets, international politics (subgenres: US, EU, etc.), international economy, science and technology, home, general articles, local articles, editorials, sports, etc. On-page advertisement genres Jaxx are publications and books, real estate, travel, home appliances and information equipment, clothing, automobiles, foods, stores, etc. On the other hand, flier genres Jdxx are volume sales stores, home appliances, furniture, clothing, real estate, automobiles, foods, stores, travel, etc. The contents of fliers are restricted to relatively small areas.

The genre list Lj is also provided to the viewer side Vw1. The genre list Lj is provided in two ways. First, the genre list Lj is provided by broadcast being carried by a data broadcast stream, and the viewer side Vw1 receives the data broadcast stream and captures the genre list Lj. Second, the viewer side Vw1 acquires the genre list Lj that is sent by data transmission over the communication medium Nw. The acquired genre list Lj is referred to by the user in performing order/selection manipulations.

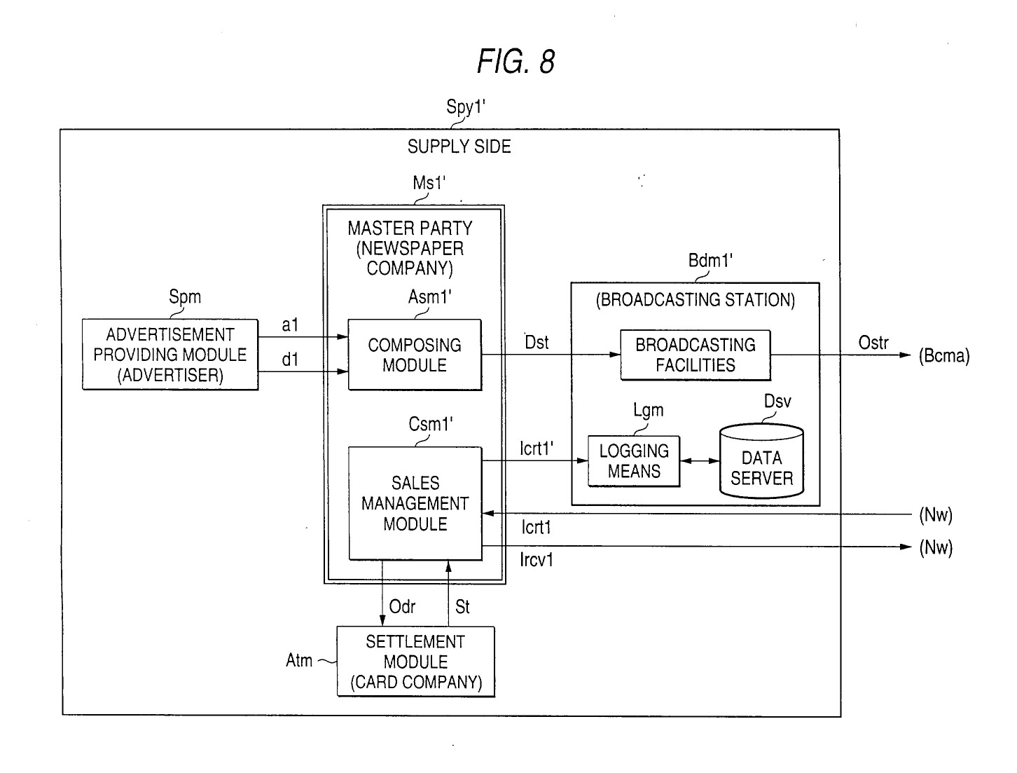

FIG. 8 is a block diagram outlining a supply side Spy1′ that is different from the one shown in FIG. 2. In the supply side Spy1′ of FIG. 8, a master party Ms1′ and the viewer side Vw1 that is the same as shown in FIG. 1 communicate with each other over the communication medium Nw directly, that is, without intervention of a broadcasting module Bdm1′, which is in contrast to the case of FIG. 1. The master party Ms1′ is equipped with a composing module Asm1′ and a sales management module Csm1′. The sales management module Csm1′ directly receives, from the viewer side vwl, order/selection information Icrt1 that is sent over the communication network Nw, and directly sends restrictive reception information Ircv1 to the viewer side Vw1 over the communication network Nw. However, the sales management module Csm1′ reports information Icrt1′ of an established contract to the broadcasting module Bdm1′ and a logging means Lgm of the broadcasting module Bdm1′ logs the contract information Icrt1′ in the data server Dsv. With this measure, the broadcasting module Bdm1′ can check whether a reward is correct as in the above-described configuration.

FIG. 9 is a block diagram showing a detailed configuration of the supply side Spy1′ of FIG. 8. As shown in FIG. 9, the composing module Asm1′ is equipped with the following means:

(1) An article generating means 800 that generates article data n1 and supplies those to a genre setting means 801 and a coding means 802.

(2) The genre setting means 801 that supplies a genre list Lj to a header adding means 806, and sets a genre for each of the article data n1 that are supplied from the article generating means 800 and on-page advertisement data a1 and/or flier data d1 that are supplied from the advertisement providing module Spm, and supplies the genres to the header adding means 806.

(3) The coding means 802 that codes the received article data n1 and on-page advertisement data a1 and/or flier data d1 into coded fragments using a coding key list 804 that is stored in a data server 803, and that supplies the coded fragments to the header adding means 806.

(4) A date/time managing means 805 that outputs date/time data.

(5) The header adding means 806 that generates article fragments fgmn and on-page advertisement fragments fgma and/or flier fragments fgmd by adding headers to the coded fragments based on the genre data supplied from the genre setting means 801, the coded fragments supplied from the coding means 802, and the date/time data supplied from the date/time managing means 805, supplies the generated fragments to a stream composing means 807, and supplies a fragment (not shown) obtained by adding a header to the genre list Lj to the stream composing means 807.

(6) The stream composing means 807 that receives the fragment of the genre list Lj and the fragments (fgmn, fgma, fgmd) having headers from the header adding means 806, composes a data stream Dst, and sends it to the broadcasting module Bdm1′.

The on-page advertisement data a1 and the flier data d1 are supplied from the advertisement providing module Spm.

The sales management module Csm1′ is equipped with the following unit and means:

(1) A communication control unit 810 that functions as an interface of bidirectional communication with the communication medium Nw.

(2) A signal decoding means 811 that decodes a signal received from the communication medium Nw.

(3) An acceptance processing means 812 that accepts the decoded signal, extracts order/selection information Icrt1 from it, and stores the order/selection information Icrt1 in a customer file 814 of the data server 803.

(4) A managing means 817 having the following functions. The managing means 817 fetches, from the customer file 814, settlement method indication data itc3 (see FIG. 1) supplied from the viewer side Vw1, requests the settlement module Atm to perform examination and settlement by sending the settlement method indication data itc3 to the settlement module Atm, and receives an examination result and a settlement completion report from the settlement module Atm. The managing means 817 stores information of an established contract in a log file 816 of the data server 803, and sends the contract information Icrt1′ to the broadcasting module Bdm1′. Further, the managing means 817 fetches subscription conditions of the viewer side Vw1 from the customer file 814 of the data server 803, fetches a corresponding decoding key from a decoding key list 815 of the data server 803 based on the subscription conditions thus obtained, and sends the subscription conditions and the decoding key to a restrictive reception information drawing-up means 818.

(5) The restrictive reception information drawing-up means 818 that draws up restrictive reception information Ircv1 based on data 817a that are supplied from the managing means 817 and contain a contract period, a genre, a decoding key, etc., and sends the restrictive reception information Ircv1 to a signal coding means 819.

(6) The signal coding means 819 that codes the received restrictive reception information Ircv1 and sends the coded restrictive reception information Ircv1 to the communication medium Nw via the communication control unit 810.

In addition to performing the above operations, the managing means 817 receives an advertisement fee af from the advertisement providing module Spm pays a settlement processing fee vf to the settlement module Atm, and pays an advertisement fee (radio waves use fee) bf to the broadcasting module Bdm1′. In addition to the advertisement fee bf, the managing means 817 may pay a reward (not shown) for establishment of a contract to the broadcasting module Bdm1′.

Although in this embodiment the managing means 817 and the settlement module Atm are connected to each other via a dedicated line 820, they may be connected to each other by some other connecting means.

Each of the above means constituting the composing module Asm1′ and the sales management module Csm1′ is prepared as a computer program. For example, the signal coding means 819 and the signal decoding means 811 are computer programs, with which the secrecy of transmission data is secured by a public key cryptosystem (different pieces of key information are used for coding and decoding) that is based on an asymmetrical coding system such as RAS or a secret-key cryptosystem such as DES or IDEA.

FIG. 10 is a block diagram showing a detailed configuration of the viewer side Vw1 of FIG. 3. The viewer side Vw1 is an information exchange apparatus and is equipped with the following components:

(1) A receiving circuit 901 that receives at least data broadcast (digital broadcast).

(2) A fragment extracting means 902 that receives a data broadcast stream from the receiving circuit 901, and selects and extracts fragments based on an extraction control signal 923b.

(3) A decoding means 903 that decodes the extracted fragments using a decoding key 923c.

(4) A home server Hsv that stores the restored fragments.

(5) A picture forming means 904 that receives restored fragments from the decoding means 903, forms a picture according to picture formation criteria that are supplied from a picture formation criteria generating means 905, and causes a display device Dpy to display the picture.

(6) The picture formation criteria generating means 905 that is equipped with a nonvolatile storage means such as a flash memory, generates picture formation criteria based on an instruction 912b that is supplied from an input processing means 912, and supplies the generated criteria to the picture forming means 904 in response to a request from it.

The receiving circuit 901, the fragment extracting means 902, and the decoding means 903 constitute the digital broadcast receiving module Drm1 shown in FIG. 3. The picture forming means 904, the picture formation criteria generating means 905, and the display device Dpy constitute the display/printing module Dym1.

The viewer side Vw1 is also equipped with the following components:

(7) A remote controller 911 that is manipulated by the user.

(8) The input processing means 912 that exchanges, with the picture forming means 904, signals 912a to be used for comparing instructions that are supplied from the remote controller 911 with the contents of a displayed picture, outputs input instructions 912c, and sends, to the picture formation criteria generating means 905, an instruction 912b relating to picture formation criteria that is supplied from the remote controller 911.

(9) An order/selection information drawing-up means 913 that receives the input instructions 912c, draws up order/selection data 913a, stores the order/selection data 913a in the home server Hsv, and outputs the order/selection data 913a as order/selection information Icrt1.

(10) A signal coding means 914 that receives the order/selection information Icrt1 from the order/selection information drawing-up means 913, codes it, and sends the coded order/selection information Icrt1 to a communication control unit NCU.

(11) The communication control unit NCU that operates as an interface of bidirectional communication with the communication medium Nw.

The viewer side Vw1 is further equipped with the following components:

(12) A signal decoding means 921 that receives a signal that is sent from the supply side Spy1′ via the communication medium Nw and the communication control unit NCU, and decodes it to restore restrictive reception information Ircv1.

(13) A restrictive reception managing means 923 that has the following functions. The restrictive reception managing means 923 receives the restored restrictive reception information Ircv1, and checks whether it is correct by comparing it with a signal 923a that is read from the home server Hsv and contains the order/selection data. Based on current date/time data that is supplied from a clock 922, the restrictive reception managing means 923 checks whether the period restriction item itm1 of the restrictive reception information Ircv1 is satisfied. If it is satisfied, the restrictive reception managing means 923 generates the above-mentioned extraction control signal 923b based on the article genre restriction item itm2, the on-page advertisement genre restriction item itm3, and the flier genre restriction item itm4 of the restrictive reception information Ircv1, and gives it to the fragment extracting means 902. Further, the restrictive reception managing means 923 generates a decoding key 923c based on decoded data contained in the restrictive reception control signal itm5 of the restrictive reception information Ircv1, and gives the decoding key 923c to the decoding means 903. Still further, the restrictive reception managing means 923 stores a signal 923a containing the above check result etc. in the home server Hsv.

The remote controller 911 and the input processing means 912 constitute the input module Imp1 shown in FIG. 3. The order/selection information drawing-up means 913, the home server Hsv, the signal coding means 914, the communication control unit NCU, the signal decoding means 921, the clock 922, and the restrictive reception managing means 923 constitute the management and communication module Ccm1.

The home server Hsv is a recording device having, as a recording medium, a large-capacity hard disc drive or a DVD-RW, for example. A recording device having a detachable, portable recording medium may be provided in addition to the home server Hsv. For example, it is preferable to use a memory stick Stk that is produced by Sony Corp.

The memory stick Stk is given to the viewer side Vw1 in advance in such a manner that form data to be used for displaying the order/selection picture as shown in FIG. 6 or the genre list Lj as shown in FIG. 7 is stored therein. Or the memory stick Stk is prepared for the viewer side Vw1 to exchange information with an external device such as a personal computer, a PDA, a fixed telephone, or a cellular telephone. In the latter case, each device is so configured as to be able to be mounted with the memory stick Stk, and exchange information through the memory stick Stk. More specifically, a data broadcast content (an article, an advertisement, or the like) received by the digital broadcast receiving module Drm1 of the viewer side Vw1 is stored in the memory stick Stk or transferred to it from the home server Hsv. Then, the memory stick Stk is mounted in such a device as the personal computer, PDA, fixed telephone, or cellular telephone, whereby the device can use the data broadcast content.

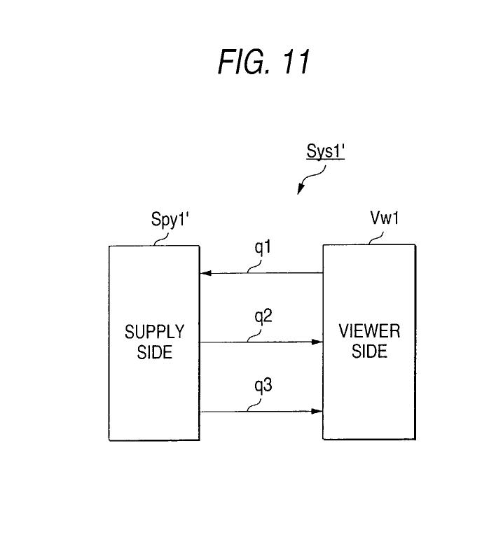

FIG. 11 is a communication sequence chart of the information exchange system Sys1′. The operations of the components of the information exchange system Sys1′ will be described below along FIG. 11 with reference to FIGS. 9 and 10. The operations of components of the information exchange system Sys1′ having substantially the same components in the information exchange system Sys1 will not be described to avoid redundant descriptions.

In the information exchange system Sys1′, a communication q1 for sending order/selection information Icrt1 from the viewer side Vw1 to the supply side Spy1′ over the communication medium Nw, a communication q2 for sending restrictive reception information Ircv1 from the supply side Spy1′ to the viewer side Vw1 over the communication medium Nw, and a communication q3 for data-broadcasting an on-air stream Ostr from the supply side Spy1′ to the viewer side Vw1 over the digital broadcasting medium Bcma are performed in order.

If the user at the viewer side Vw1 wants to make a subscription contract and input order-related instructions on a displayed picture by manipulating the remote controller 911, the image forming means 904 receives a resulting signal 912a from the input processing means 912. Then, the image forming means 904 reads an order/selection picture form that is stored in the memory stick Stk or the home server Hsv and causes the display device Dpy to display it. Similarly, the image forming means 904 reads the genre list Lj and has it displayed.

If the user follows a registration procedure on the order/selection picture (see FIG. 6), specifies a subscription-desired publishing source and a subscription period, and specifies a genre by referring to the genre list Lj, the input processing means 912 outputs resulting input instructions 912c. In response, the order/selection information drawing-up means 913 draws up order/selection data 913a, stores it in the home server Hsv, and sends it to the signal coding means 914 as order/selection information Icrt1. The order/selection information Icrt1 is coded by the signal coding means 914 and transmitted to the supply side Spy1′ via the communication control unit NCU and the communication medium Nw.

In the supply side Spy1′ , the signal decoding means 811 of the sales management module Csm1′ receives the order/selection information Icrt1 via the communication control unit 810 and decodes it. The acceptance processing means 812 stores the decoded order/selection information Icrt1 in the customer file 814 of the data server 803. Then, the managing means 817 extracts the settlement method indication data itc3 of the stored order/selection information Icrt1 and calculates an amount of money of a contract. The managing means 817 sends the calculated value to the settlement module Atm over the dedicated line 820 and requests the settlement module Atm to perform examination and settlement. The settlement module Atm examines the bank account of the viewer side Vw1 based on the settlement method indication data itc3 and the amount of money of a contract. If judging that the bank account is good, the settlement module Atm performs settlement processing such as payment from the bank account of a credit card and reports a settlement result to the managing means 817.

Receiving the settlement result, the managing means 817 pays a settlement processing fee vf to the settlement module Atm, stores the contents of the established contract in the log file 816 of the data server 803, sends contract information Icrt′ to the broadcasting module Bdm1′, and pays an advertisement fee (radio waves use fee) bf to the broadcasting module Bdm1′. Further, the managing means 817 fetches the subscription conditions of the viewer side Vw1 from the customer file 814 of the data server 803, fetches a corresponding decoding key from the decoding key list 815 of the data server 803 based on the subscription conditions, and sends the subscription conditions and the decoding key to the restrictive reception information drawing-up means 818.

Based on data 817a that are received from the managing means 817 and contain the subscription period, genre, decoding key, etc., the restrictive reception information drawing-up means 818 draws up restrictive reception information Ircv1 to be used for permitting capture of information fragments that conform to the specified details, and sends it to the signal coding means 819. The restrictive reception information Ircv1 contains a period indication item itm1, an article genre restriction item itm2, an on-page advertisement genre restriction item itm3, a flier genre restriction item itm4, and a restrictive reception control signal itm5. The signal coding means 819 codes the received restrictive reception information Ircv1 and sends the coded restrictive reception information Ircv1 to the viewer side Vw1 via the communication control unit 810 and the communication medium Nw.

On the other hand, the article generating means 800 of the composing module Asm1′ generates article data n1 and supplies those to the genre setting means 801 and the coding means 802. The advertisement providing module Spm supplies on-page advertisement data a1 and/or flier data d1 to the genre setting means 801 and the coding means 802, and pays an advertisement fee af to the managing means 817. The genre setting means 801 sets a genre for each of the received article data n1 and on-page advertisement data a1 and/or flier data d1, and supplies the genres to the header adding means 806. The coding means 802 codes the received article data n1 and on-page advertisement data a1 and/or flier data d1 into coded fragments using the coding key list 804 that is stored in the data server 803, and supplies the coded fragments to the header adding means 806.

The header adding means 806 generates fragments by adding headers to the coded fragments based on the genre data supplied from the genre setting means 801, the coded fragments supplied from the coding means 802, and date/time data supplied from the date/time managing means 805, and supplies the generated fragments to the stream composing means 807. The stream composing means 807 receives the fragments having the headers from the header adding means 806, composes a data stream Dst, and sends it to the broadcasting module Bdm1′. The broadcasting module Bdm1′ converts the received data stream Dst into a data broadcast stream, composes an on-air stream Ostr based on the data broadcast stream and a separately prepared TV program stream, and broadcasts the on-air stream Ostr digitally. Further, the broadcasting module Bdm1′ logs the contract information Icrt′ that is supplied from the managing means 817, and checks, based on the contract information Icrt′, an advertisement fee (radio waves use fee) bf upon its reception from the managing means 817.

On the other hand, the signal decoding means 921 of the viewer side Vw1 receives the signal that is sent from the supply side Spy1′ via the communication medium Nw and the communication control unit NCU, decodes it to restore the restrictive reception information Ircv1, and supplies the restrictive reception information Ircv1 to the restrictive reception managing means 923. The restrictive reception managing means 923 receives the restored restrictive reception information Ircv1, and checks whether it is correct by comparing it with a signal 923a that is read from the home server Hsv and contains the order/selection data. Based on current date/time data that is supplied from the clock 922, the restrictive reception managing means 923 checks whether the period restriction item itm1 of the restrictive reception information Ircv1 is satisfied. If it is satisfied (i.e., the current date/time is within in the specified period), the restrictive reception managing means 923 generates an extraction control signal 923b based on the article genre restriction item itm2, the on-page advertisement genre restriction item itm3, and the flier genre restriction item itm4 of the restrictive reception information Ircv1, and gives those to the fragment extracting means 902. Further, the restrictive reception managing means 923 generates a decoding key 923c based on decoded data contained in the restrictive reception control signal itm5 of the restrictive reception information Ircv1, and gives the decoding key 923c to the decoding means 903. Still further, the restrictive reception managing means 923 stores a signal 923a containing the above check results etc. in the home server Hsv.

The receiving circuit 901 receives the on-air stream Ostr that is being broadcast digitally and supplies the data broadcast stream to the fragment extracting means 902. The fragment extracting means 902 selects and extracts fragments based on an extraction control signal 923b, and supplies those to the decoding means 903. The decoding means 903 decodes the extracted fragments using a decoding key 923c and supplies the decoded fragments to the picture forming means 904. The decoding means 903 stores the decoded fragments in the home server Hsv. Alternatively, the decoded fragments may be stored in the memory stick Stk. The picture forming means 904 receives restored fragments from the decoding means 903 or reads fragments from the home server Hsv or the memory stick Stk. The picture forming means 904 forms a picture according to picture formation criteria that are supplied from the picture formation criteria generating means 905, and causes the display device Dpy to display the picture.

During the above course, the managing means 817 manages the time when it outputs the signal 817a, which makes it possible to deliver articles of the newspaper for which the viewer side Vw1 has made the contract and selected advertisements to the viewer side Vw1 at specified time.

The article generating means 800 updates the article data n1 constantly, which makes it possible to deliver chargeable information that is updated constantly. For example, where the article data n1 are updated every 15 minutes, if the viewer side Vw1 makes, by time designation, an instruction to the effect that information is read at 7:00, article data that have been broadcast from 6:45 are read at 7:00. Alternatively, article data that are broadcast at 6:45 are stored in the home server Hsv or the like and then played back and read at 7:00.

In the above embodiment, the supply side sends chargeable information by data broadcast during broadcast of TV programs. However, the invention is not limited to such a case; it is possible to send chargeable information as primary TV broadcast while no TV programs are being broadcast. In this case, chargeable information can be provided to the viewer side by either of primary TV broadcast and data broadcast.

As described above, according to this embodiment, the degree of freedom of contract including the subscription period is high and a publishing source (e.g., a newspaper company) and a genre can be selected freely on an article basis. Therefore, the viewer side can specify and purchase only desired information and can acquire only advertisements of a certain genre that the user is interested in or is necessary. The viewer side is required to pay for only acquired information, and need not pay a communication fee because information is delivered by data broadcast; the viewer side can acquire information at a low cost.

The viewer side can easily make a contract or alter the contents of a contract by a bidirectional communication. Provided with an information storing function, the viewer side can store delivered information and search for and see part of the stored information when necessary. Since necessary ones of newspaper articles, on-page advertisements, or fliers can be selected and printed, wasteful consumption of paper and undue loss that accompanies printing can be prevented to enable effective use of resources. This embodiment is very efficient in this respect.

Where the master party is a local newspaper company, a system may be constructed in which a local broadcasting company broadcasts, in the local area, a data broadcast stream containing articles and advertisements relating to the local area, whereby the advertising effect can be enhanced and the role of the local broadcasting station can be increased.

Further, this embodiment enables a business of providing articles or advertisements for pay by data broadcast. This is business model that is proposed by the invention in which articles or advertisements are data-broadcast to a viewer side over a broadcasting medium and bidirectional information exchange with the viewer side is performed over a communication medium. Articles or advertisements are converted into information fragments of various genres, which are data-broadcast after being coded. On the other hand, a chargeable provision contract having contract conditions including an arbitrary genre of information fragments to be provided for pay and an arbitrary effective period is made with the viewer side. After making the contract, restrictive reception information to be used for decoding only information fragments that satisfy the contract conditions is given to the viewer side via the communication medium and settlement is also performed.

Having the above-described advantages, this business model can provide services that are efficient, economical, highly convenient.

FIGS. 12 and 13 are block diagrams showing the configurations of a supply side Spy2 and a viewer side Vw2, respectively, of another information exchange system (second embodiment) Sys2 to which another information exchange method according to the invention is applied. The information exchange system Sys2 of this embodiment realizes a restrictive reception function by a simplified configuration in which no special decoding is performed for data broadcast.

Components of this embodiment having (approximately) the same components in the preceding embodiment are given the same reference symbols as the latter and will not be described to avoid redundant descriptions.

The supply side Spy2 of the information exchange system Sys2 is equipped with the following means and modules:

(1) An article generating means 1100 that generates article data n1 and supplies those to a genre setting means 1101.

(2) An advertisement providing module Spm that supplies on-page advertisement data a1 and/or flier data d1 to the genre setting means 1101, and pays an advertisement fee af to a managing means 1116.

(3) The genre setting means 1101 that sets a genre for each of the article data n1 that are supplied from the article generating means 1100 and the on-page advertisement data al and/or the flier data d1 that are supplied from the advertisement providing module Spm, and supplies the data n1 and a1 and/or d1 and data of the thus-set genres to a header adding means 806.

(4) A date/time managing means 805 that outputs date/time data.

(5) The header adding means 806 that generates fragments having headers by adding headers to the data n1 and a1 and/or d1 based on the genre data supplied from the genre setting means 1101, the data n1 and a1 and/or d1, and the date/time data supplied from the date/time managing means 805, and supplies the generated fragments to a stream composing means 807.

(6) The stream composing means 807 that receives the fragments having headers and other data from the header adding means 806, composes a data stream Dst, and sends it to a broadcasting module Bdm2.

(7) The broadcasting module Bdm2 that converts the data stream Dst into a data broadcast stream, composes an on-air stream Ostr containing the data broadcast stream, and broadcasts the on-air stream Ostr digitally.

The supply side Spy2 is also equipped with the following unit and means:

(8) A communication control unit 810 that functions as an interface of bidirectional communication with the communication medium Nw.

(9) A signal decoding means 811 that decodes a signal received from the communication medium Nw.

(10) An acceptance processing means 812 that accepts the decoded signal, extracts order/selection information Icrt1 from it, and stores the order/selection information Icrt1 in a customer file 814 of a data server 1113.

(11) A managing means 1116 having the following functions. The managing means 1116 receives an advertisement fee af from the advertisement providing module Spm, fetches, from the customer file 814, settlement method indication data itc3 supplied from the viewer side Vw2, requests a settlement module Atm to perform examination and settlement by sending the settlement method indication data itc3 to the settlement module Atm, and receives an examination result and a settlement completion report from the settlement module Atm. The managing means 1116 pays a settlement processing fee vf to the settlement module Atm, stores information of an established contract in a log file 816 of the data server 1113, and sends the contract information Icrt′ to the broadcasting module Bdm2. Further, the managing means 1116 pays an advertisement fee (radio waves use fee) bf to the broadcasting module Bdm2, fetches subscription conditions of the viewer side Vw2 from the customer file 814 of the data server 1113, and sends the subscription conditions to a restrictive reception control signal drawing-up means 1117.

(12) The restrictive reception control signal drawing-up means 1117 that draws up a restrictive reception control signal Ircv2 based on data 817a that are supplied from the managing means 1116 and contain a contract period, a genre, etc., and sends the restrictive reception control signal Ircv2 to a signal coding means 819. The restrictive reception control signal Ircv2 contains a permission period, a permission genre, etc. and is a control signal that allows the viewer side Vw2 to check the contents of the headers of fragments and turn on/off the receiving function by making a judgment based on the period, genre, etc.

(13) The signal coding means 819 that codes the received restrictive reception control signal Ircv2 and sends the coded restrictive reception control signal Ircv2 to the communication medium Nw via the communication control unit 810.

In addition to the advertisement fee bf, the managing means 1116 may pay a reward (not shown) for establishment of a contract to the broadcasting module Bdm2.

As understood from the above description, the supply side Spy2 is different in operation from the previously described supply side Spy1′ in that a header (indicating a genre and a date/time) is added to each uncoded fragment data and a sequence of a plurality of fragments is broadcast as a digital broadcast stream. Further, the restrictive reception control signal drawing-up means 1117 sends the viewer side Vw2 a restrictive reception control signal Ircv2 that allows the viewer side Vw2 to turn on/off part of the functions of the viewer side Vw2 instead of sending a decoding key to the viewer side Vw2.

The viewer side Vw2 is an information exchange apparatus and is equipped with the following components:

(1) A receiving circuit 901 that receives at least data broadcast (digital broadcast).

(2) A fragment selecting means 1202 that receives a data broadcast stream from the receiving circuit 901, and passes only conformable fragments based on a control signal 1223b.

(3) A home server Hsv that stores the fragments that have passed through the fragment selecting means 1202.

(4) A picture forming means 904 that receives fragments from the fragment selecting means 1202 or fetches stored fragments from the home server Hsv, forms a picture according to criteria that are supplied from a picture formation criteria generating means 905, and causes a display device Dpy to display the picture.

(5) The picture formation criteria generating means 905 that is equipped with a nonvolatile storage means such as a flash memory, generates picture formation criteria based on an instruction 912b that is supplied from an input processing means 912, and supplies the generated criteria to the picture forming means 904 in response to a request from it.

(6) A remote controller 911 that is manipulated by the user.

(7) The input processing means 912 that exchanges, with the picture forming means 904, signals 912a to be used for comparing instructions that are supplied from the remote controller 911 with the contents of a displayed picture, outputs input instructions 912c, and sends, to the picture formation criteria generating means 905, an instruction 912b relating to picture formation criteria that is supplied from the remote controller 911.

(8) An order/selection information drawing-up means 913 that receives the input instructions 912c, draws up order/selection data 913a, stores the order/selection data 913a in the home server Hsv, and outputs the order/selection data 913a as order/selection information Icrt1.

(9) A signal coding means 914 that receives the order/selection information Icrt1 from the order/selection information drawing-up means 913, codes it, and sends the coded order/selection information Icrt1 to a communication control unit NCU.

(10) The communication control unit NCU that operates as an interface of bidirectional communication with the communication medium Nw.

The viewer side Vw2 is also equipped with the following components:

(11) A signal decoding means 921 that receives a signal that is sent from the supply side Spy2 via the communication medium Nw and the communication control unit NCU, decodes it, and supplies the decoded signal to a restrictive reception managing means 1223.

(12) The restrictive reception managing means 1223 that has the following functions. The restrictive reception managing means 1123 extracts a restrictive reception control signal Ircv2 from the signal supplied from the signal decoding means 921, and checks whether it is correct by comparing it with a signal 1223a that is read from the home server Hsv and contains order/selection data. Based on current date/time data that is supplied from a clock 922, the restrictive reception managing means 1223 checks whether the permission period indicated by the restrictive reception control signal Ircv2 is satisfied. If it is satisfied (i.e., the current date/time is within in the permission period), the restrictive reception managing means 1223 generates a control signal 1223b based on a genre indicated by the restrictive reception control signal Ircv2 and gives it to the fragment extracting means 902. Further, the restrictive reception managing means 1223 stores a signal 923a containing the above check result etc. in the home server Hsv.

As understood from the above description, the viewer side vw2 is different in operation from the previously described viewer side Vw1 in that upon reception of a digital data stream the fragment selecting means 1202 reads information of headers and passes only permitted fragments baced or a signal 1223b and interrupts and discards the other fragments.

As described above, in the information exchange system Sys2 according to this embodiment, the supply side Spy2 does not perform any special coding for data broadcast and hence the viewer side Vw2 which is simplified in configuration performs restrictive selection without performing decoding. Although the information exchange system Sys2 is less strict than the previously described information exchange system Spy1′ using coding and decoding in terms of prevention of improper reception of data broadcast, the information exchange system Sys2 can be used for general purposes because it is an inexpensive system and still enables restrictive reception.

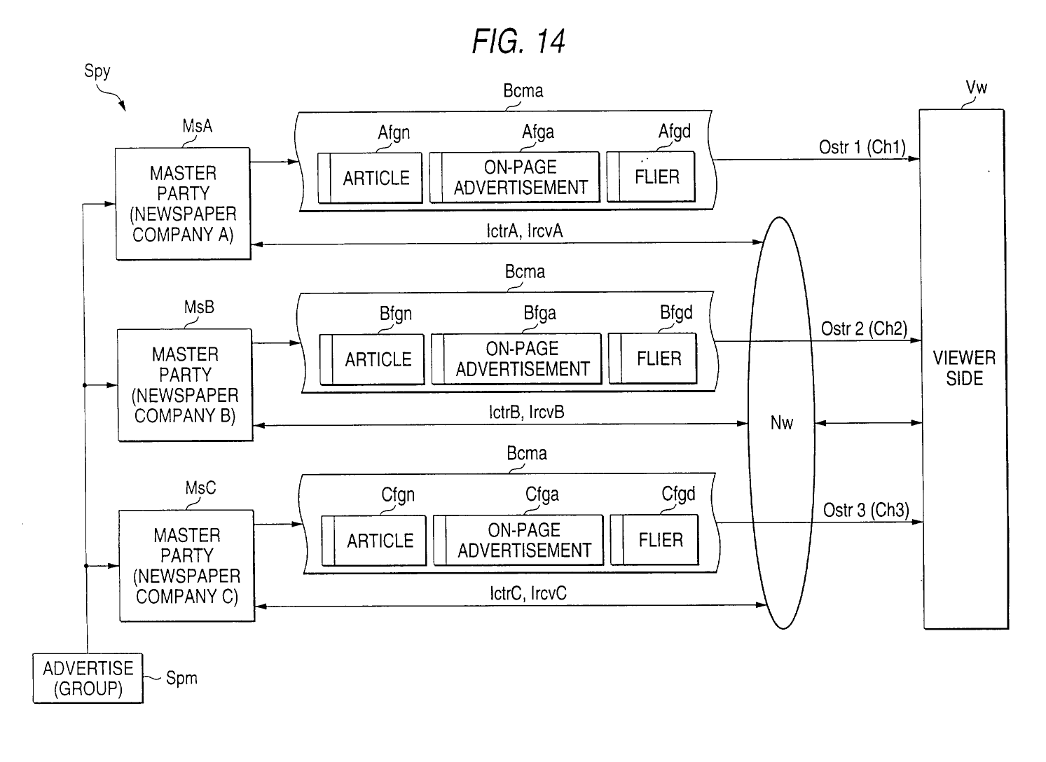

FIG. 14 illustrates an information exchange system in which the supply side consists of a plurality of master parties. Although to facilitate its understanding each of the above embodiments was described by using the drawings in which the master party and the viewer side are in one-to-one correspondence, there actually occur a “one-to-multiple” case in which many viewer sides correspond to one master party as well as a “multiple-to-multiple” case in which many viewer sides correspond to a plurality of master parties.

As shown in FIG. 14, a master party MsA that is newspaper company A, for example, has an on-air stream Ostr1 broadcast digitally on channel Ch1. The on-air stream Ostr1 carries broadcast contents that are a sequence of an article fragment Afgn, an on-page advertisement fragment Afga, and a flier fragment Afgd. A master party MsB that is newspaper company B, for example, has an on-air stream Ostr2 broadcast digitally on channel Ch2. The on-air stream Ostr2 carries broadcast contents that are a sequence of an article fragment Bfgn, an on-page advertisement fragment Bfga, and a flier fragment Bfgd. A similar operation is performed for a master party MsC.

Although there exist an indefinite number of viewing sides Vw actually, for the sake of convenience FIG. 14 shows the “multiple-to-one” case. The viewer side Vw can receive a plurality of on-air streams Ostr1-Ostr3 by channel selection. Further, the viewer side Vw can make chargeable subscription contracts with the individual master parties MsA-MsC by exchanging pieces of order/selection information IctrA-IctrC and pieces of restrictive reception information IrcvA-IrcvC with the master parties MsA-MsC, respectively. In FIG. 14, there are a plurality of advertisement request parties Spm.

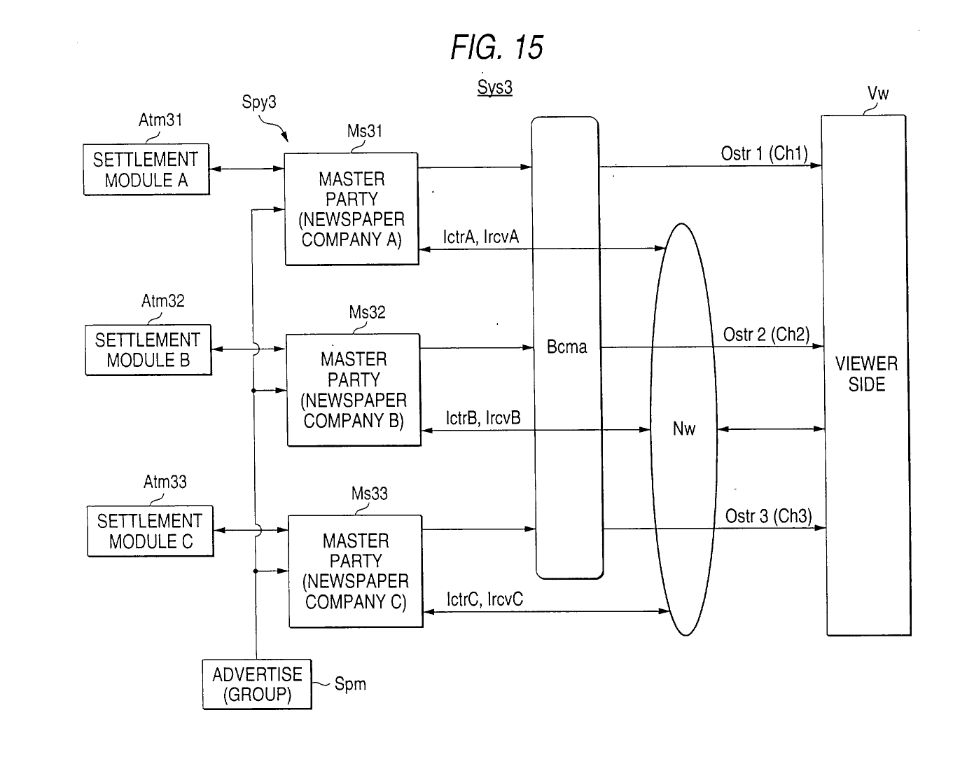

FIG. 15 outlines the configuration of another information exchange system (third embodiment) Sys3 to which another information exchange method according to the invention is applied. In the information exchange system Sys3, a “multiple-to-multiple” configuration is formed by a plurality of master parties Ms31-Ms33 and a plurality of viewer sides Vw. A plurality of settlement modules Atm3l-Atm33 perform settlement for the respective master parties Ms31-Ms33. The corresponding relationship shown in FIG. 15 between the master parties and the settlement modules is just an example, and it goes without saying that other various corresponding relationships are possible.

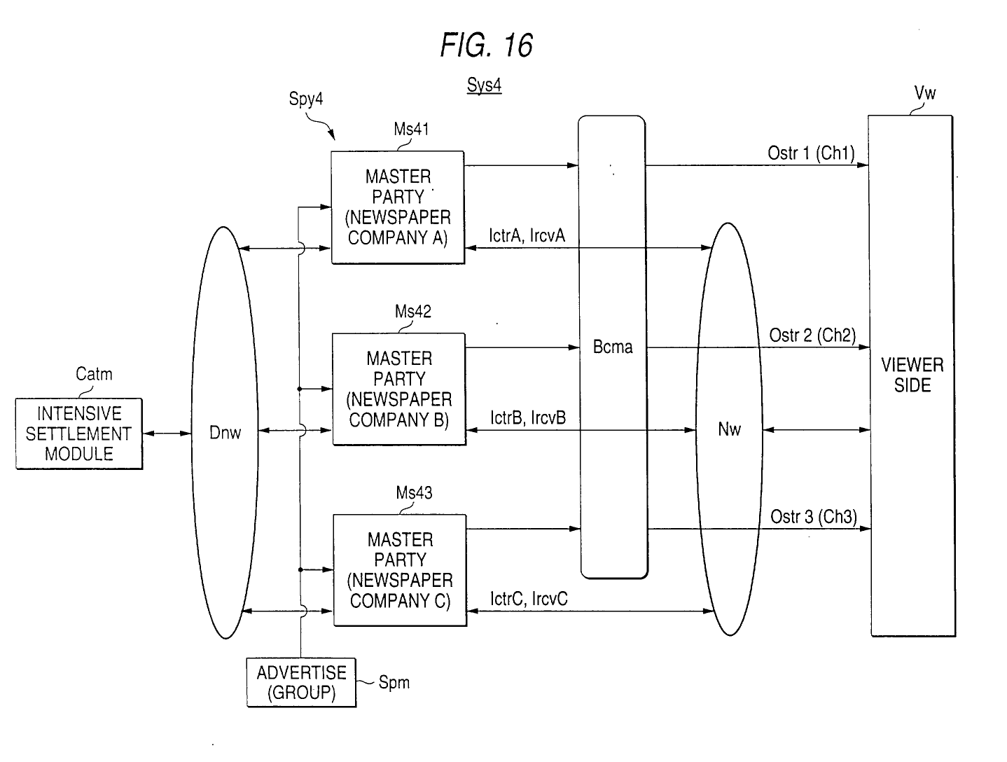

FIG. 16 outlines the configuration of another information exchange system (fourth embodiment) Sys4 to which another information exchange method according to the invention is applied. In the information exchange system Sys4, a “multiple-to-multiple” configuration is formed by a plurality of master parties Ms41-Ms43 and a plurality of viewer sides Vw. An intensive settlement module Catm is under contract with the master parties Ms41-Ms43 and performs settlement therefor. Each of the master parties Ms41-Ms43 is connected to the intensive settlement module Catm by lines Dnw, an example of which is the Internet.

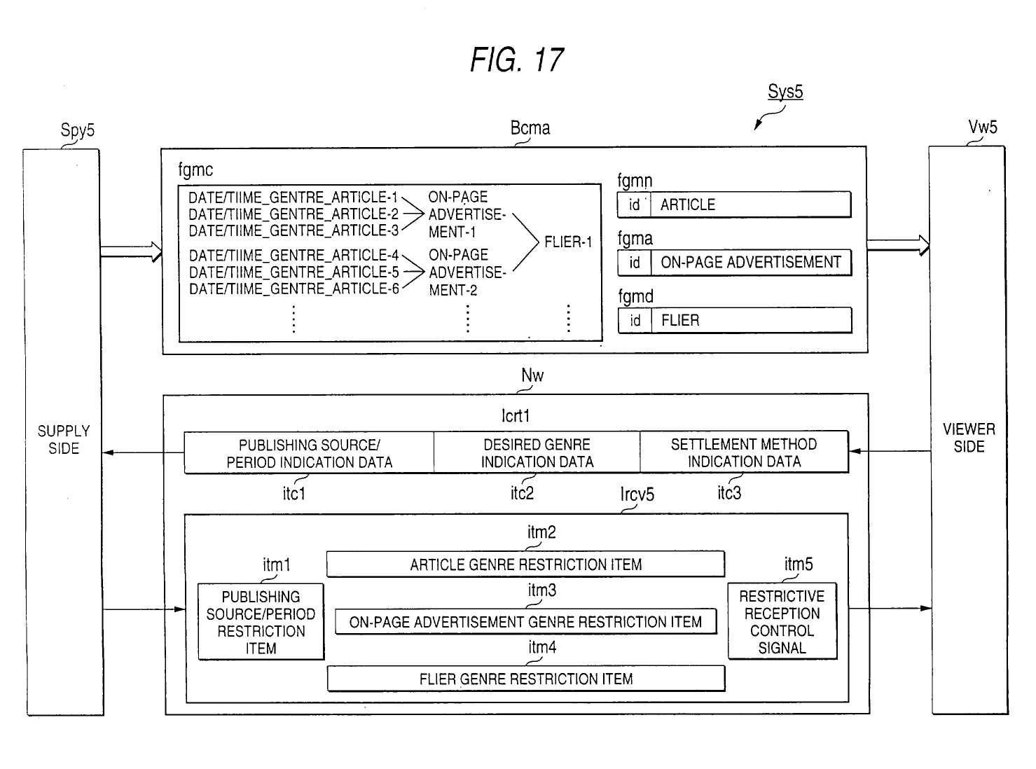

FIG. 17 outlines the configuration of another information exchange system (fifth embodiment) Sys5 to which another information exchange method according to the invention is applied. The information exchange system Sys5 has a function that a supply side Spy5 supplies information that links articles and advertisements to each other and if a viewer side Vw captures an article, for example, and has it displayed, an advertisement that is linked to the article is also displayed automatically. Components of this embodiment having (approximately) the same components in any of the above embodiments are given the same reference symbols as the latter and will not be described to avoid redundant descriptions.

The information exchange system Sys5 is equipped with a supply side Spy5, a viewer side Vw5, and a broadcasting medium Bcma and a communication medium Nw that serve for information exchange between them.

The supply side Spy5 draws up article fragments fgmh, on-page advertisement fragments fgma, and flier fragments fgmd based on information contents, and draws up a control fragment fgmc that indicates links between fragments based on a link correspondence table indicating information that links a predetermined on-page advertisement fragment fgma and/or flier fragment fgmd to an arbitrary article fragment fgmn. The supply side Spy5 composes a data broadcast stream from those fragments and broadcasts the data broadcast stream over the digital broadcasting medium Bcma by its own digital broadcasting function.

Further, the supply side Spy5 receives order/selection information Icrt1 (approximately the same as the one shown in FIG. 1) from the viewer side vw5 by a bidirectional communication function, establishes a contract for chargeable information provision, and sends, to the viewer side Vw5, over the communication medium Nw, restrictive reception information Ircv5 to be used for capturing only fragments as subjects of chargeable provision and fragments linked to those from a data broadcast stream. Still further, the supply side Spy5 collects, from the viewer side Vw5, a charge for chargeable information provision according to the contract.

The viewer side Vw5 makes a contract for chargeable information provision by generating order/selection information Icrt1 in which desired subscription conditions are set, and sends it to the supply side Spy5 over the communication medium Nw. When receiving, over the communication medium Nw, restrictive reception information Ircv5 that reflects the subscription conditions, the viewer side Vw5 captures, based on the contents of the restrictive reception information Ircv5, only capture-permitted fragments and fragments that are linked to the former by a control fragment. The captures fragments are displayed, stored, or printed in a linked manner according to the control fragment.

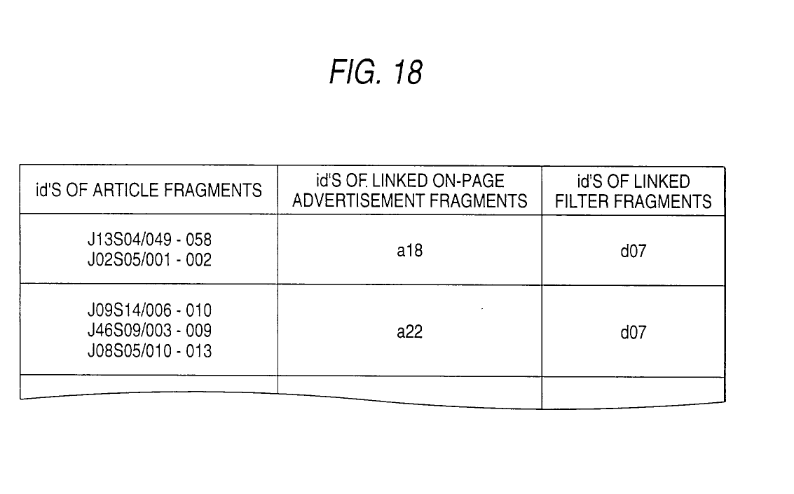

FIG. 18 shows an exemplary link correspondence table Ltab that correlates article fragments with advertisement fragments. The link correspondence table Ltab correlates identification numbers of article fragments with identification numbers of on-page advertisement fragments and identification numbers of flier fragments that are linked to the article fragments.

In the link correspondence table Ltab, an on-page fragment having an identification number a18 and a flier fragment having an identification number d07 are linked to article fragments having identification numbers J13S04_{—}049 to J13S04_{—}58 and J02S05_{—}001 to J02S05_{—}002.

Therefore, when at least one of the above article fragments is captured, the on-page advertisement fragment (identification number: a18) and the flier fragment (identification number: d07) that are linked to the captured article fragment are also captured simultaneously and these fragments are displayed or printed together.

Similarly, an on-page fragment having an identification number a22 and the flier fragment having the identification number d07 are linked to article fragments having identification numbers J09S14_{—}006 to J09S14_{—}010 etc. Therefore, when at least one of those article fragments is captured, the on-page advertisement fragment (identification number: a22) and the flier fragment (identification number: d07) that are linked to the captured article fragment are also captured simultaneously and these fragments are displayed or printed together.

An advertiser (sponsor) may make a setting that a plurality of articles to its own advertisement, in which case the advertisement is necessarily displayed when one of the articles is read. Therefore, chances of appealing to customers increases to provide a pronounced advertising effect. Since the correspondence can be set or altered freely, articles themselves and the number of articles can be changed in a flexible manner, which makes it possible to always set links having highest cost performance.

A control fragment fgmc (described above) is drawn up based on the link correspondence table Ltab. As shown in FIG. 17, items “date/time_genre_article number” are correlated with an on-page advertisement number, which is correlated with a flier number.

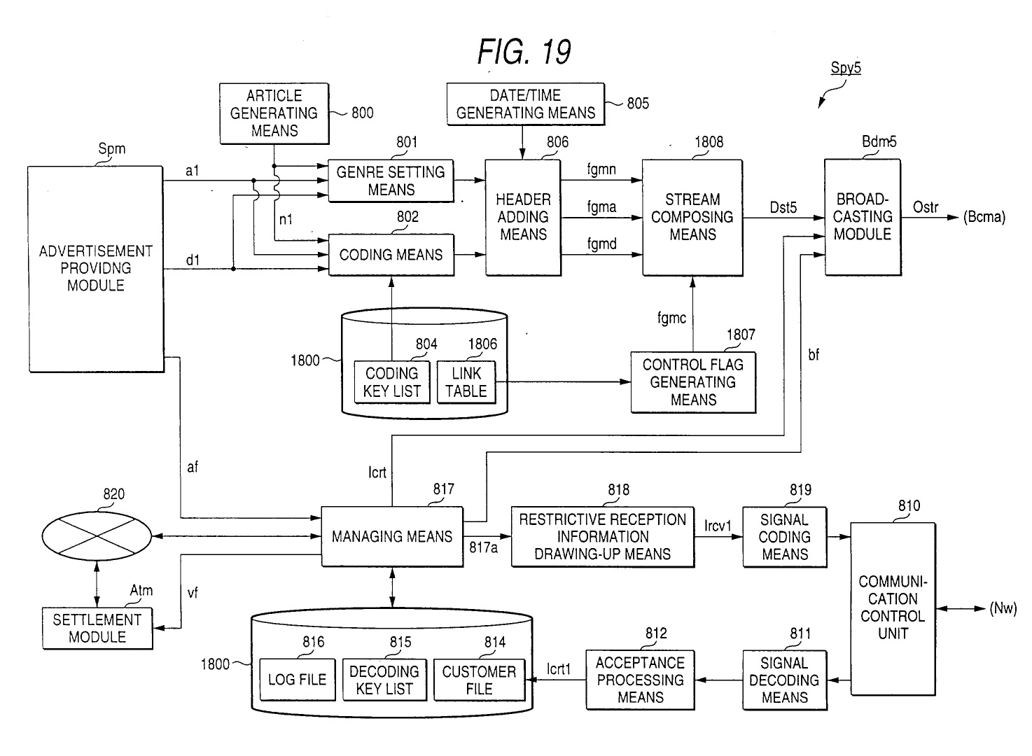

FIG. 19 is a block diagram showing the configuration of the supply side Spy5 of the information exchange system Sys5 of FIG. 17. Components in FIG. 19 having the same components of any of the above embodiments are given the same reference symbols as the latter and will not be described to avoid redundant descriptions.

The supply side Spy5 is equipped with the following means and modules:

(1) An article generating means 800 that generates article data n1 and supplies those to a genre setting means 801 and a coding means 802.

(2) An advertisement providing module Spm that supplies on-page advertisement data a1 and/or flier data d1 to the genre setting means 801 and the coding means 802, and pays an advertisement fee af to a managing means 817.

(3) The genre setting means 801 that supplies a genre list Lj (see FIG. 7) to a header adding means 806, sets a genre for each of the article data n1 that are supplied from the article generating means 800 and the on-page advertisement data a1 and/or the flier data d1 that are supplied from the advertisement providing module Spm, and supplies the genres to the header adding means 806.

(4) The coding means 802 that codes the received article data n1 and on-page advertisement data a1 and/or flier data d1 into coded fragments using a coding key list 804 that is stored in a data server 1800, and that supplies the coded fragments to the header adding means 806.

(5) A date/time managing means 805 that outputs date/time data.

(6) The header adding means 806 that generates fragments having headers (fgmn, fgma, fgmd) by adding headers to the coded fragments based on the genre data supplied from the genre setting means 801, the coded fragments supplied from the coding means 802, and the date/time data supplied from the date/time managing means 805 and also generates a fragment (not shown) in which a header is added to the genre list Lj, and supplies the generated fragments to a stream composing means 1808.

(7) A control fragment generating means 1807 that generates a control fragment fgmc using a link table 1806 that is stored in the data server 1800, and supplies it to the stream composing means 1808.

(8) The stream composing means 1808 that receives the fragment of the genre list Lj and the fragments (fgmn, fgma, fgmd) having headers from the header adding means 806 and also receives the control fragment fgmc from the control fragment generating means 1807, composes a data stream Dst5 containing those fragments, and sends it to a broadcasting module Bdm5.

(9) The broadcasting module Bdm5 that converts the received data stream Dst5 into a data broadcast stream, composes an on-air stream Ostr containing the data broadcast stream, and broadcasts the on-air stream Ostr digitally.

The supply side Spy5 is also equipped with a communication control unit 810, a signal decoding means 811, an acceptance processing means 812, a managing means 817, a restrictive reception information drawing-up means 818, a signal coding means 819, and a dedicated line 820, which are approximately the same in configuration as those in the previous embodiment.

As understood from the above description, the supply side Spy5 that is equipped with the control fragment generating means 1807 is different in operation from the previously described supply side Spy1′ in that a control fragment fgmc indicating a link state (table) 1806 between article fragments and advertisement fragments (on-page advertisement fragments and flier fragments) is generated and a data broadcast stream carrying the control fragment fgmc is broadcast digitally.

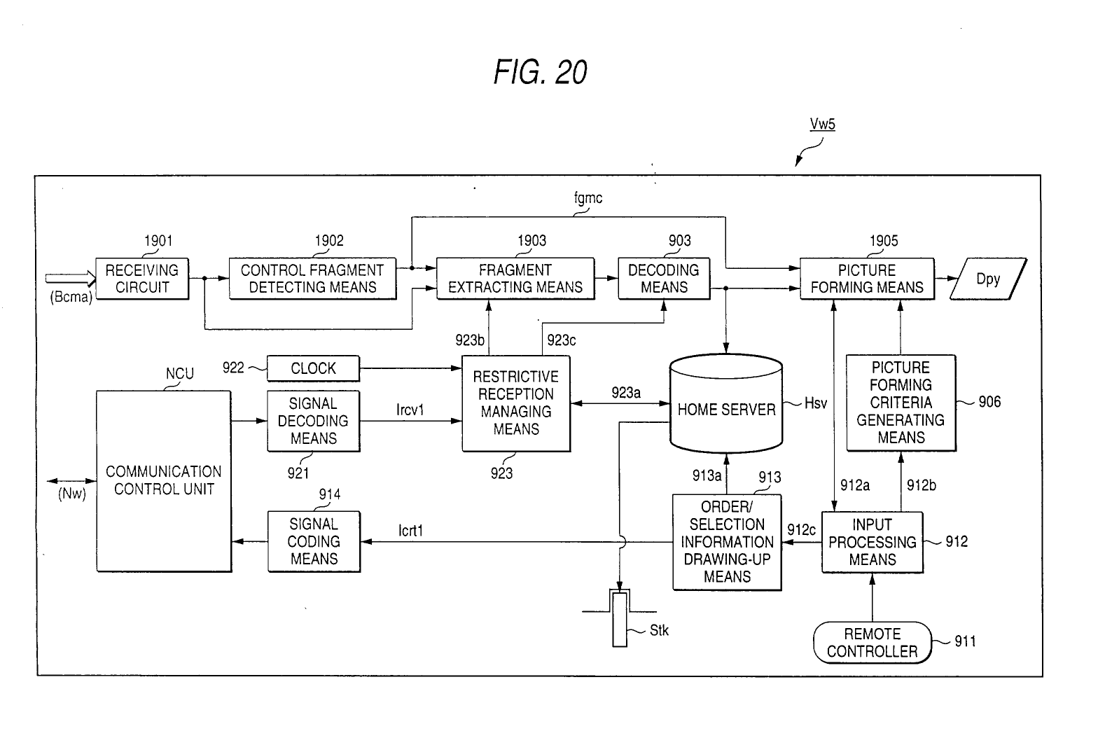

FIG. 20 is a block diagram showing the configuration of the viewer side Vw5 of the information exchange system Sys5 of FIG. 17. Components in FIG. 20 having the same components of any of the above embodiments are given the same reference symbols as the latter and will not be described to avoid redundant descriptions.

The viewer side Vw5 is an information exchange apparatus and is equipped with the following components:

(1) A receiving circuit 1901 that receives data broadcast and supplies a data broadcast stream to a control fragment detecting means 1902 and a fragment extracting means 1903.

(2) The control fragment detecting means 1902 that detects a control fragment fgmc from the received data broadcast stream, and supplies it to the fragment extracting means 1903 and a picture forming means 1905.

(3) The fragment extracting means 1903 that receives the data broadcast stream, the control fragment fgmc, and an extraction control signal 923b from the receiving circuit 1901, the control fragment detecting means 1902, and a restrictive reception managing means 923, respectively. The fragment extracting means 1903 first extracts, from the data broadcast stream, article fragments fgmn and/or advertisement fragments (on-page advertisement fragments fgma and flier fragments fgmd) that conform to the extraction control signal 923b. Then, the fragment extracting means 1903, from the data broadcast stream, fragments that are linked to each of the extracted fragments by referring to the control fragment fgmc, and sends all the extracted fragments to a decoding means 903.

(4) The decoding means 903 that decodes the fragments received from the fragment extracting means 1903 using a decoding key 923c, and that sends the decoded fragments to the picture forming means 1905 or store those in a home server Hsv.

(5) The home server Hsv that stores the restored fragments.

(6) The picture forming means 1905 that receives the control fragment fgmc from the control fragment detecting means 1902, receives restored fragments from the decoding means 903 or reads stored fragments from the home server Hsv, forms a picture according to picture formation criteria 906 that are supplied from a picture formation criteria generating means 905, and causes a display device Dpy to display the fragments that are linked to each other.

The viewer side Vw5 is also equipped with the picture formation criteria generating means 905, a remote controller 911, an input processing means 912, an order/selection information drawing-up means 913, a signal coding means 914, a communication control unit NCU, a signal decoding means 921, a clock 922, and a restrictive reception managing means 923, which are approximately the same in configuration as those in the previous embodiment.

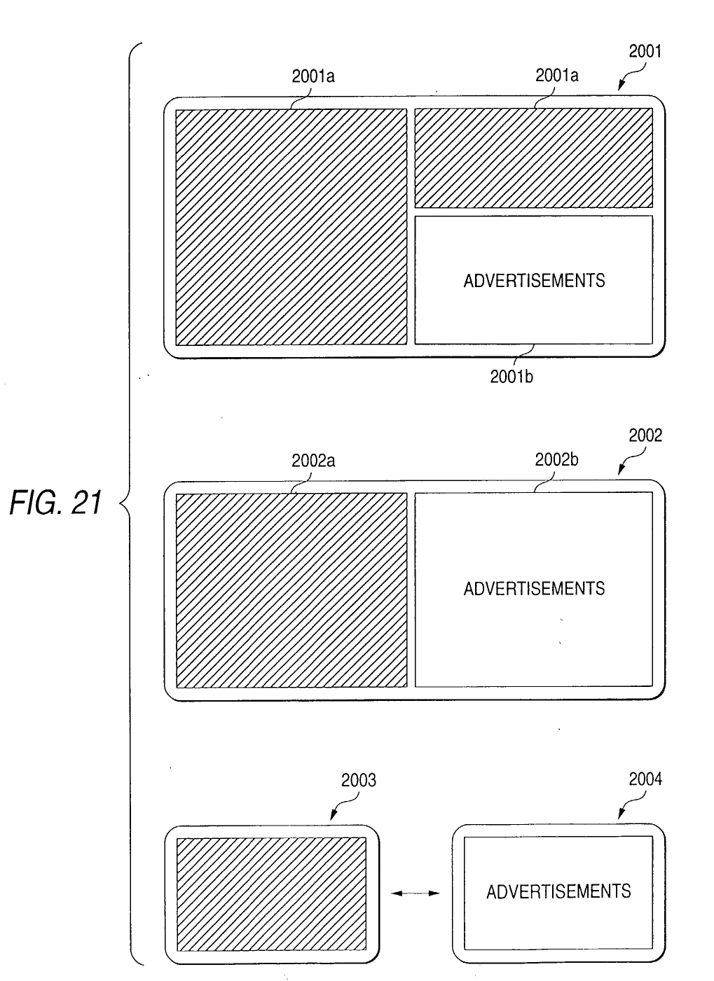

FIG. 21 shows exemplary pictures. In setting a picture by inputting a picture formation instruction 912b to the picture formation criteria generating means 906 via the input processing means 912 from the remote controller 911, it is particularly important how to simultaneously display both of an article and an advertisement that is linked to the article. In a picture 2001, advertisements (on-page advertisements and/or fliers) 2001b are superimposed on or substituted for part of whole articles 2001a. If the advertisements 2001b come to hinder the user from reading the articles 2001a, he can move or eliminate the advertisements 2001b.

On the other hand, a picture 2002 is of a two-part type picture, in which one part is used for display of articles 2002a and the other is used for display of advertisements 2002b.

As a further alternative, switching may be made between articles 2003 and advertisements 2004 in their entirety. One of the two picture formations can be specified by the signal 912b.

In this embodiment, as for the link between article fragments and advertisement fragments, the supply side Spy5 generates an articles/advertisements correspondence table (link table) and the link table is transmitted being carried by a digital broadcast stream. Another configuration is possible in which a link table is sent to the viewer side Vw5 being transmitted over a communication path other than a broadcasting medium. Receiving the link table, the viewer side Vw5 captures only article fragments and advertisement fragments that are specified based on the link table and displays or prints those fragments. Still another configuration is possible in which at least part of a link table is stored in the memory stick Stk and supplied to the viewer side Vw5 in package form.

As understood from the above description, the viewer side Vw5 is different in configuration from the previously described viewer side vw1 in the following points. Equipped with the control fragment detecting means 1902, the viewer side Vw5 detects a control fragment fgmc from a data broadcast stream, captures link-specified article fragments fgmn and advertisement fragments fgma and/or fgmd from the data broadcast stream, and displays the fragments that are linked to each other.

As described above, according to this embodiment, article fragments are correlated with advertisement fragments in the supply side Spy5 and the viewer side Vw5 displays or prints both kinds of fragments simultaneously when the user makes an instruction to display or print one kind of fragments. In this manner, the user can simultaneously see necessary news articles and advertisements relating to those or vice versa efficiently without the need for performing cumbersome manipulations. This enhances the advertising effect and the convenience of the user.

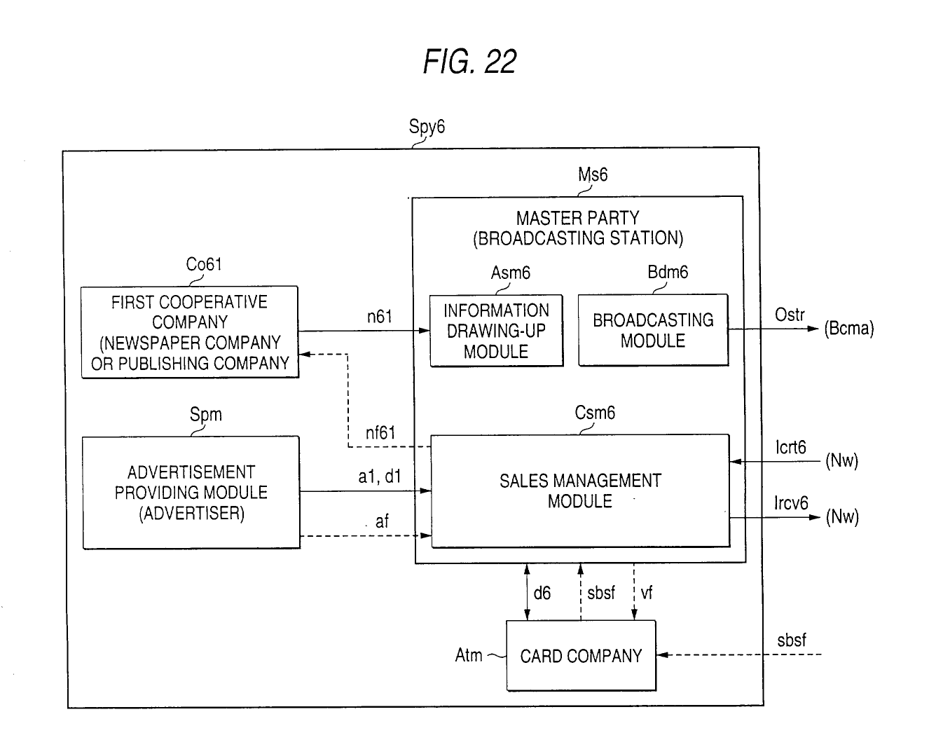

FIG. 22 shows a business model of still another information exchange system (sixth embodiment) Sys6 to which another information exchange method according to the invention is applied. A master party Ms6 that is a component of a supply side Spy6 of this business model is a broadcasting station, which is different than in the business model of the above embodiments. That is, in this business model, the broadcasting station that is a broadcasting company having a license that operates a contents sending system (digital broadcasting facilities) resells, by itself, bought-in information contents such as articles and advertisements as an information resale company.

In the information exchange system Sys6 (not shown) of this business model that is equipped with the supply side Spy6 and a viewer side Vw6 (not shown), information is transmitted unidirectionally by digital broadcast by a digital broadcasting medium Bcma and bidirectional communications are performed over a bidirectional communication medium Nw. The supply side Spy6 consists of the master party Ms6, an advertiser (advertisement providing module) Spm, a newspaper company, a publishing company, or the like (first cooperative company) Co61, and a card company (settlement module) Atm.

The master party Ms6 is equipped with an information drawing-up module Asm6, a sales management module Csm6, and a broadcasting module Bdm6 as digital broadcasting facilities. The information drawing-up module Asm6 buys in articles n61 from the first cooperative company Co61, and is supplied with on-page advertisement data a1 and/or flier data d1 from the advertiser Spm via the sales management module Csm6. The information drawing-up module Asm6 draws up data broadcast contents using those information materials and causes the broadcasting module Bdm6 to broadcast those in the form of an on-air stream Ostr. The on-air stream Ostr contains articles and on-page advertisements and/or fliers as well as link information (described above) indicating how articles and advertisements (on-page advertisements and/or fliers) are linked to each other.

The sales management module Csm6 sends, to the information drawing-up module Ams6, on-page advertisement data a1 and/or flier data d1 that are received from the advertiser Spm, receives an advertisement fee af from the advertiser Spm, and pays an article price nf61 to the first cooperative company Co61. When receiving order/selection information Icrt6 that is sent from the viewer side Vw6 over the communication medium Nw, the sales management module Csm6 makes a subscription contract with the viewer side Vw6 and send restrictive reception information Ircv6 to the viewer side Vw6. Further, exchanging accounting data d6 with the card company Atm, the sales management module Csm6 requests the card company Atm to perform settlement and receives a settlement result from the card company Atm.

The card company Atm charges the viewer side Vw6, collects a fee, and informs the sales management module Csm6 about a fee collection result. By making a subscription contract and paying a subscription flee sbcf, the viewer side Vw6 can subscribe, through digital broadcast, articles of a desired newspaper or publication of a desired genre for an arbitrary period.

The advertiser Spm provides on-page advertisement data a1 and/or flier data d1 to the information drawing-up module Asm6 of the master party Ms6 via the sales management module Csm6, and pays an advertisement fee af to the sales management module Csm6 of the master party Ms6.

The first cooperative company Co61, which is a publishing company, a newspaper company that provides news articles for pay, or another broadcasting station, provides article information for pay by making a contract with the master party Ms6. The information that is provided by the first cooperative company Co61 is not limited to article information; the first cooperative company Co61 may provide, for pay, information materials that are combinations of articles and advertisements. In this case, the first cooperative company Co61 receives an advertisement fee from the advertiser Spm by directly making a contract with it, and receives, from the master party Ms6, a fee for provision of information materials that are combinations of articles and advertisements.

In particular, where the master party Ms6 operates in a local area, the first cooperative companies Co61 may include a central key broadcasting station in addition to various publishing sources. In this case, the master party Ms6 itself can edit broadcast contents of the key broadcasting station and resell resulting contents.

The master party Ms6 and the viewer side Vw6 exchange order/selection information Icrt6 including settlement method indication data and restrictive reception information Ircv6 with each other via the bidirectional communication medium Nw in the same manner as in the above embodiments.

According to this business model, in contrast to conventional news delivery services etc. using the Internet, information contents are delivered by data broadcast. Therefore, the viewer side Vw6 is not charged any transmission fees and hence can receive information contents at a low cost.

The income and expenditure of each company in this business model will be summarized below. The advertiser Spm pays an advertisement fee af to the master party Ms6. The first cooperative company Co61 receives an article provision fee nf61 from the master party Ms6. The viewer side Vw6 pays a subscription fee sbsf to the card company Atm. The card company Atm passes the collected subscription fee sbsf to the master party Ms6, who pays a settlement fee vf to the card company Atm.

Therefore, the master party Ms6 has the advertisement fee af and the subscription fee sbsf as incomes and has the information contents purchase fee nf61, the settlement fee vf, and various expenses as expenditures. The difference is a gross margin.

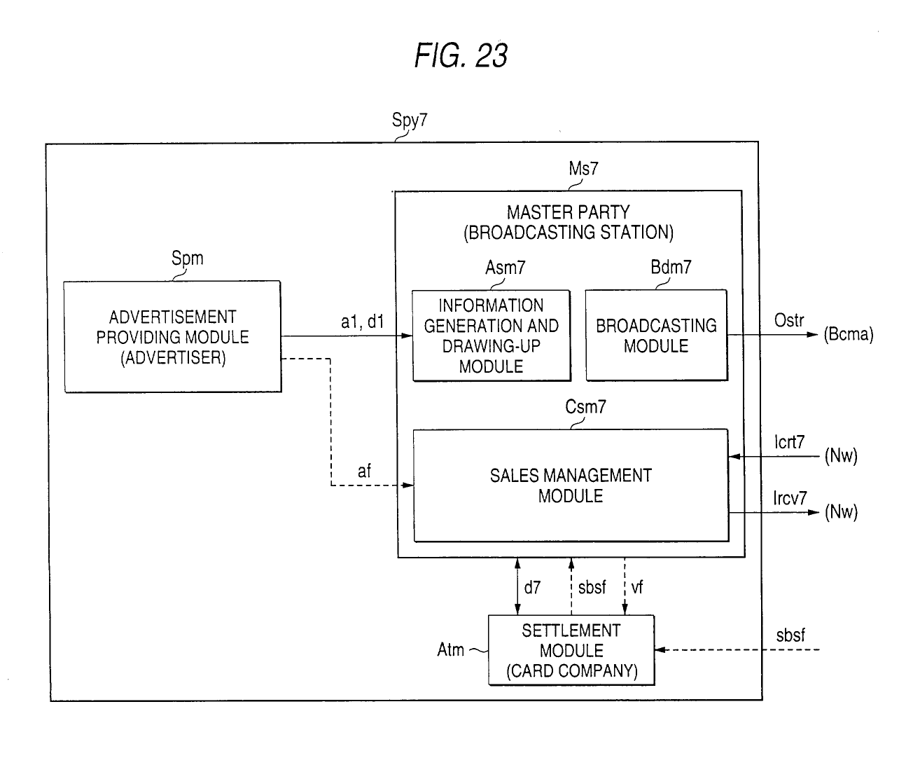

FIG. 23 shows a business model of yet another information exchange system (seventh embodiment) Sys7 to which another information exchange method according to the invention is applied. A master party Ms7 that is a component of a supply side Spy7 of this business model is a broadcasting station that is a broadcasting company having a license that operates digital broadcasting facilities, which is the same as in the business of model of the sixth embodiment. However, this business model is different from the business model of the sixth embodiment in that the master party Ms7 itself generates articles rather than buys in articles from external sources.

In the information exchange system Sys7 (not shown) of this business model that is equipped with the supply side Spy7 and a viewer side Vw7 (not shown), information is transmitted unidirectionally by digital broadcast by a digital broadcasting medium Bcma and bidirectional communications are performed over a bidirectional communication medium Nw. The supply side Spy7 consists of the master party Ms7 that is a broadcasting station, an advertiser (advertisement providing module) Spm, and a card company (settlement module) Atm.

The master party Ms7 is equipped with an information generation and drawing-up module Asm7, a sales management module Csm7, and a broadcasting module Bdm7 as digital broadcasting facilities. The information generation and drawing-up module Asm7 generates articles and is supplied with on-page advertisement data a1 and/or flier data d1 from the advertiser Spm. The information generation and drawing-up module Asm7 draws up data broadcast contents using those information materials and causes the broadcasting module Bdm7 to broadcast those in the form of an on-air stream Ostr. The on-air stream Ostr contains articles and on-page advertisements and/or fliers as well as link information (described above) indicating how articles and advertisements (on-page advertisements and/or fliers) are linked to each other.

The sales management module Csm7 receives an advertisement fee af from the advertiser Spm. When receiving order/selection information Icrt7 that is sent from the viewer side Vw7 over the communication medium Nw, the sales management module Csm7 makes a subscription contract with the viewer side Vw7 and send restrictive reception information ircv7 to the viewer side Vw7. Further, exchanging accounting data d7 with the card company Atm, the sales management module Csm7 requests the card company Atm to perform settlement and receives a settlement result from the card company Atm.

The card company Atm charges the viewer side Vw7, collects a fee, and informs the sales management module Csm7 about a fee collection result. By making a subscription contract and paying a subscription fee sbsf, the viewer side Vw7 can subscribe, through digital broadcast, articles of a desired newspaper or publication of a desired genre for an arbitrary period.

The advertiser Spm provides on-page advertisement data a1 and/or flier data d1 to the information generation and drawing-up module Asm7 of the master party Ms7 via the sales management module Csm6, and pays an advertisement fee af to the sales management module Csm7 of the master party Ms7.

The master party Ms7 and the viewer side Vw7 exchange order/selection information Icrt7 including settlement method indication data and restrictive reception information Ircv7 with each other via the bidirectional communication medium Nw.

According to this business model, information contents are delivered by data broadcast. Therefore, the viewer side Vw7 is not charged any transmission fees and hence can receive information contents at a low cost.

The income and expenditure of each company in this business model will be summarized below. The advertiser Spm pays an advertisement fee af to the master party Ms7. The viewer side Vw7 pays a subscription fee sbsf to the card company Atm. The card company Atm passes the collected subscription fee sbsf to the master party Ms7, who pays a settlement fee vf to the card company Atm.

Therefore, the master party Ms7 has the advertisement fee af and the subscription fee sbsf as incomes and has the settlement fee vf and various expenses as expenditures.

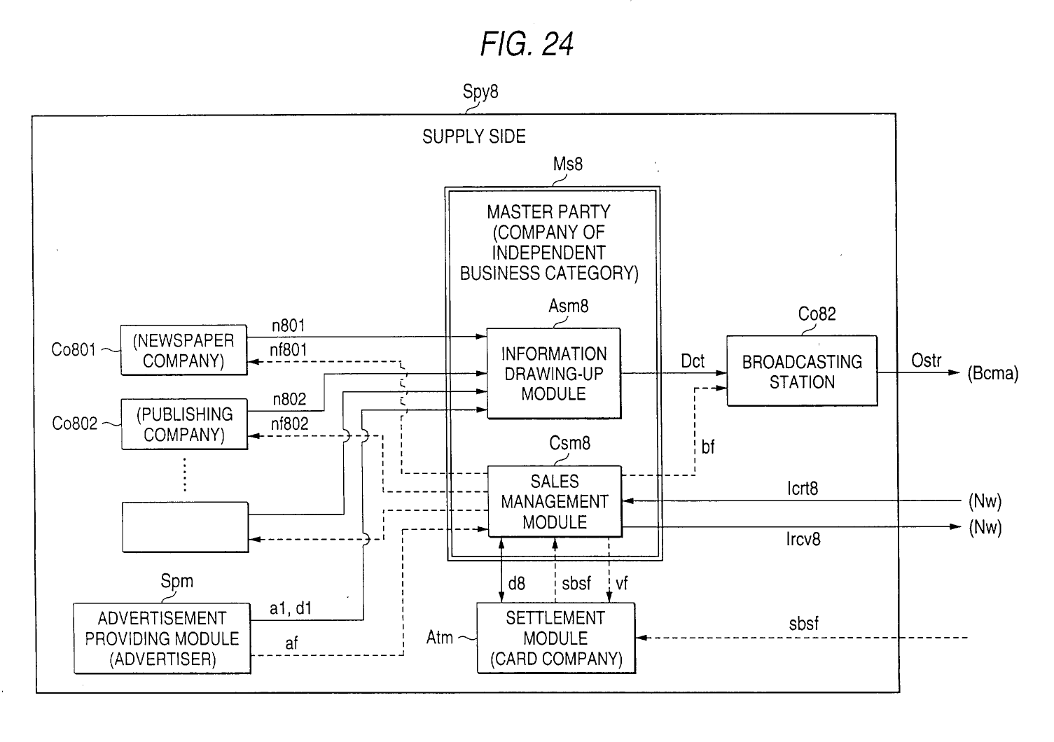

FIG. 24 shows a business model of a further information exchange system (eighth embodiment) Sys8 to which another information exchange method according to the invention is applied. A master party Ms8 that is a component of a supply side Spy8 of this business model is a new, independent company that is not a publishing source (newspaper company or publishing company) or a broadcasting station and that resells such information as bought-in articles and advertisements, which is different than in the business models of the above embodiments. That is, in this business model, the master party Ms8 is an information resale company.

In the information exchange system Sys8 (not shown) of this business model that is equipped with the supply side Spy8 and a viewer side Vw8 (not shown), information is transmitted unidirectionally by digital broadcast by a digital broadcasting medium Bcma and bidirectional communications are performed over a bidirectional communication medium Nw. The supply side Spy8 consists of the master party Ms8, an advertiser (advertisement providing module) Spm, a plurality of first cooperative companies Co801, Co802, etc. such as a newspaper company and a publishing company, a broadcasting station (second cooperative company) Co82, and a card company (settlement module) Atm.

The master party Ms8 is equipped with an information drawing-up module Asm8 and a sales management module Csm8. The information drawing-up module Asm8 buys in articles n801, n802, etc. from the first cooperative companies Co801, Co802, etc., and is supplied with on-page advertisement data a1 and/or flier data d1 from the advertiser Spm. The information drawing-up module Asm8 draws up data broadcast contents Dct using those information materials and sends the data broadcast contents Dct to the second cooperative company Co82. The drawn-up data broadcast contents Dct contain articles and on-page advertisements and/or fliers as well as link information (described above) indicating how articles and advertisements (on-page advertisements and/or fliers) are linked to each other.

The sales management module Csm8 receives an advertisement fee at from the advertiser Spm, and pays article prices nf801, nf802, etc. to the first cooperative companies Co801, Co802, etc. When receiving order/selection information Icrt8 that is sent from the viewer side Vw8 over the communication medium Nw, the sales management module Csm8 makes a subscription contract with the viewer side Vw8 and send restrictive reception information Ircv8 to the viewer side vw8. Further, exchanging accounting data d8 with the card company Atm, the sales management module Csm8 requests the card company Atm to perform settlement and receives a settlement result from the card company Atm.

The card company Atm charges the viewer side Vw8, collects a fee, and informs the sales management module Csm8 about a fee collection result. By making a subscription contract and paying a subscription fee sbsf, the viewer side Vw8 can subscribe articles of a desired newspaper or publication of a desired genre for an arbitrary period. Therefore, the viewer side Vw8 can acquire information contents of a desired genre from a plurality of newspapers, magazines, etc. for a desired period. For such subscriptions, the viewer side Vw8 is required to pay subscription fees to only one party in a collective manner.

The advertiser Spm requests the master party Ms8 to deliver on-page advertisements and/or fliers. The advertiser Spm provides on-page advertisement data a1 and/or flier data d1 to the information drawing-up module Asm8 of the master party Ms8, and pays an advertisement fee af to the sales management module Csm8 of the master party Ms8.

A publishing company, a newspaper company that provides news articles for pay, and a broadcasting station provides as the first cooperative companies Co801, Co802, etc. provide article information for pay by making a contract with the master party Ms8. The information that is provided by the first cooperative companies Co801, Co802, etc. is not limited to article information; the first cooperative companies Co801, Co802, etc. may provide, for pay, information materials that are combinations of articles and advertisements. In this case, each of the first cooperative companies Co801, Co802, etc. receives an advertisement fee from the advertiser Spm by directly making a contract with it, and receives, from the master party Ms8, a fee for provision of information materials that are combinations of articles and advertisements.

Usually, to increase the number of kinds of information to resell and the number of pieces of information of each kind, the master party Ms8 makes contracts with a plurality of first cooperative companies Co801, Co802, etc.

In particular, where the master party Ms8 operates in a local area, the first cooperative companies Co801, 802, etc. may include a central key broadcasting station in addition to various publishing sources as mentioned above. In this case, the master party Ms8 itself can edit broadcast contents of the key broadcasting station and resell resulting contents. In this case, a local broadcasting station serves as the second cooperative company Co82 and cooperates to perform the editing and actual broadcast.

The second cooperative company Co82 broadcasts broadcast contents digitally based on a request from the master party Ms8, and is a broadcasting station, that is, a broadcasting company having a license that operates a contents sending system (digital broadcasting facilities). Therefore, the master party Ms8 is a truster broadcasting company and the second cooperative company Co82 as a trustee broadcasts requested broadcast contents digitally to the viewer side Vw8. A plurality of second cooperative companies Co82 may be provided.

The master party Ms8 and the viewer side Vw8 exchange order/selection information Icrt8 including settlement method indication data and restrictive reception information Ircv8 with each other via the bidirectional communication medium Nw in the same manner as in the above embodiments. Instead of the master party Ms8's directly exchanging order/selection information Icrt8 and restrictive reception information Ircv8 with the viewer side Vw8, the broadcasting station as the second cooperative company Co82 may exchange those with the viewer side Vw8 on behalf of the master party Ms8 based on a request from the master party Ms8.

According to this business model, when, for example, the master party Ms8 purchases news articles from a plurality of newspaper companies and causes digital broadcast of data broadcast contents as a mixture of those news articles on a single channel, the viewer side Vw8 can purchase the news articles of those newspaper companies merely by tuning itself to that channel. That is, merely by indicating a genre to a browser, the viewer side Vw8 can capture all pieces of information belonging to the genre that are provided by a plurality of publishing sources.

Therefore, a cumbersome manipulation of changing the channel every time a target newspaper company should be changed is not necessary at all. No time and labor are needed to pay fees to respective newspaper companies; payment should be made only to the master party Ms8 with which a contract was made.

Further, in contrast to conventional news delivery services etc. using the Internet, information contents are delivered by data broadcast. Therefore, the viewer side Vw8 is not charged any transmission fees and hence can receive information contents at a low cost.

It can be said that the convenience of the viewer side Vw8 is enhanced to a large extent. Further, the master party Ms8 can collect a variety of articles from a plurality of material sources and hence prepare abundant information contents as subjects of resale, which makes it possible to secure a larger number of chargeable subscribers (viewer sides Vw8) and increase sales. As mentioned above, the information contents as a subject of resale is not limited to articles and a combination of articles and advertisements is also a subject of resale. The effects of linking articles with advertisements on the viewer side Vw8 are the same as described in each of the embodiments having such a feature.

The income and expenditure of each company in this business model will be summarized below. The advertiser Spm pays an advertisement fee af to the master party Ms8. The first cooperative companies Co801, Co802, etc. receive respective article provision fees nf801, nf802, etc. from the master party Ms8. The second cooperative company Co82 receives a fee for broadcast such as a radio waves use fee bf from the master party Ms8. The second cooperative company Co82 may also receive a reward from the master party Ms8 when a subscription contract is established between the master party Ms8 and the viewer side Vw8.

The viewer side Vw8 pays a subscription fee sbsf to the card company Atm. The card company Atm passes the collected subscription fee sbsf to the master party Ms8, who pays a settlement fee vf to the card company Atm.

Therefore, the master party Ms8 has the advertisement fee af and the subscription fee sbsf as incomes and has the information contents purchase fees nf801, nf802, etc., the radio waves use fee bf, the settlement fee vf, and various expenses as expenditures. The difference is a gross margin.

As described above, according to the business model of the third embodiment, a company of a third-party-like business category that is not a newspaper company, a publication company, or a broadcasting company can do business relating to resale of information contents such as publications.

As described above, the invention provides the following advantages:

(1) The viewer side as a subscriber can capture only necessary articles or advertisements by specifying a desired genre and publishing source and a subscription period. Therefore, the degree of freedom of contract is high and the subscriber is required to pay a fee of only captures articles or advertisements. The cost performance can be increased.

(2) In particular, by virtue of increase in the degree of freedom in setting a subscription period, short-term subscription and irregular subscription are enabled. That is, a subscriber can make a contract for only a desired time or period.

(3) Since information as a subject of subscription is transmitted by contents delivery, the subscriber need not pay a line use fee and hence the cost is low.

(4) Since information reaches a subscriber immediately, latest information can be supplied to the subscriber. Further, the information can be updated constantly.

(5) Loss of paper and printing ink due to printing of unnecessary information does not occur and manual delivery is unnecessary. Elimination of such waste lowers the cost.

(6) Since only necessary part of information as a subject of subscription can be selected and printed, wasteful consumption of paper is prevented, which means efficient use of resources.

(7) By specifying a reception time, latest information can be received at that time.

(8) The contents of past newspapers or advertisements can be stored and searched later.

(9) A comprehensive subscription contract can be made if a plurality of information publishing sources are involved, which is convenient.

(10) Since an on-page advertisement or a flier can be correlated with each article, or an article or articles can be correlated with each on-page advertisement or flier, the advertising effect is enhanced, which is good news to advertisers. A subscriber can save time and labor for extracting necessary ones of a certain genre from a very large number of fliers, which is convenient to him.

(11) A third-party-like company that is not any of a newspaper company, a publishing company, and a broadcasting company that are involved in the information resale business conventionally can enter into that business.

As described above, the invention provides a business model for providing articles and advertisements for pay by contents delivery, comprising the steps of converting articles or advertisements into information fragments of various genres, and coding and delivering the information fragments; making, with the viewer side, a chargeable provision contract having contract conditions including an arbitrary genre and an arbitrary effective period by performing bidirectional information exchange with the viewer side over the communication medium; and after making the chargeable provision contract, giving the viewer side, via the communication medium, a restrictive reception control signal to be used for decoding only information fragments that satisfy the contract conditions. Since the viewer side can freely specify a desired genre, a period, etc. via the communication medium and subscribe desired information contents, the degree of freedom of contract is increased. The viewer side need not pay for a cost of transmitting information fragments, and can be supplied with latest information. Further, constant updating of information can be performed easily. As a result, services providing pronounced economic effects are enabled.

The invention provides an information exchange method comprising a first step, executed by the supply side, of drawing up information fragments and broadcasting a contents delivery stream containing the information fragments; a second step, executed by the viewer side, of sending order/selection information to the supply side over the communication medium; a third step, executed by the supply side, of sending restrictive reception information to the viewer side over the communication medium; a fourth step, executed by the supply side, of performing processing of charging the viewer side; and a fifth step, executed by the viewer side, of capturing information fragments that conform to instructions from the contents delivery stream based on the restrictive reception information. Therefore, the viewer side need not pay for a cost of transmitting information fragments. Since information reaches the viewer side immediately, latest information can be supplied to the user side. The viewer side can acquire constantly updated information. Further, unlike the case of printed publications, paper is not consumed wastefully. Still further, since the viewer side can make a subscription contract by freely specifying a desired genre, a period, etc. via the communication medium, the degree of freedom of contract is increased.

Further, settlement processing is simplified because it is performed by the supply side based on order/selection information that is received via the communication medium.

The invention provides another information exchange method comprising a first step, executed by the supply side, of drawing up information fragments, generating article/advertisement correspondence information, and delivering a contents delivery stream containing the information fragments and the article/advertisement correspondence information; a second step, executed by the viewer side, of sending order/selection information to the supply side over the communication medium; a third step, executed by the supply side, of sending restrictive reception information to the viewer side over the communication medium; a fourth step, executed by the supply side, of performing processing of charging the viewer side; and a fifth step, executed by the viewer side, of capturing, from the contents delivery stream, information fragments that conform to instructions and information fragments that are correlated with the former information fragments from the contents delivery stream based on the restrictive reception information and the article/advertisement correspondence information. Therefore, the supply side can freely correlate articles with advertisements. When the correspondence between articles and advertisement needs to be altered, the only measure to be taken is to alter the contents of article/advertisement correspondence information. Further, settlement processing is simplified because it is performed based on order/selection information that is received via the communication medium.

The viewer side need not pay for a cost of transmitting information fragments and article/advertisement correspondence information. Since information reaches the viewer side immediately, latest information can be supplied to the user side. The viewer side can acquire constantly updated information. Further, unlike the case of printed publications, paper is not consumed wastefully. Still further, since the viewer side can make a subscription contract by freely specifying a desired genre, a period, etc. via the communication medium, the degree of freedom of contract is increased.

Further, in capturing articles or advertisements based on restrictive reception information, an advertisement that is correlated with an article in advance or an article that is correlated with an advertisement in advance is captured based on article/advertisement correspondence information, which makes it possible to simultaneously display the article and the advertisement correlated with it or the advertisement and the article correlated with it.

Each of the above information exchange methods may be such that the first step sends the contents delivery stream to the viewer side after coding at least the information fragments; the third step causes the restrictive reception information to include decoding information to be used for decoding at least coded information fragments; and the fifth step decodes captured coded information fragments based on the decoding information received. In this case, a content delivery stream whose safety is secured by coding and decoding can be received in a restricted manner.

Each of the above information exchange methods may be such that the third step causes the restrictive reception information to include control information to be used for causing the viewer side to capture only information fragments that conform to the instructions or only the information fragments that conform to the instructions and information fragments that are correlated with the information fragments that conform to the instructions; and the fifth step captures only information fragments that conform to the instructions or only the information fragments that conform to the instructions and information fragments that are correlated with the information fragments that conform to the instructions from the contents delivery stream based on the control information. In this case, a content delivery stream whose safety is secured by a simplified mechanism that does not employ coding and decoding can be received in a restricted manner. In particular, only articles and advertisements correlated with those can be received.

The invention provides an information exchange system wherein, in the supply side, drawing-up means draws up information fragments, delivering means delivers the information fragments, sending and receiving means receives order information from the viewer side via the communication medium and sends restrictive reception information to the viewer side over the communication medium, and settling means performs processing of charging the viewer side. In the viewer side, sending and receiving means sends the order information to the supply side over the communication medium and receives the restrictive reception information from the supply side via the communication medium, and information fragments receiving means captures information fragments that conform to instructions from a contents delivery stream based on the restrictive reception information. Therefore, the viewer side need not pay for a cost of transmitting information fragments. Since information reaches the viewer side immediately, the viewer side can acquire latest information, that is, constantly updated information. Unlike the case of printed publications, paper is not consumed wastefully. Since the viewer side can make a subscription contract by freely specifying a desired genre, a period, etc. via the communication medium, the degree of freedom of contract is increased.

Further, settlement processing can be simplified because it is performed based on order information that is sent over the communication medium.

The invention provides another information exchange system wherein, in the supply side, drawing-up means draws up information fragments, article/advertisement correlating means generates article/advertisement correspondence information, delivering means delivers the information fragments and the article/advertisement correspondence information, sending and receiving means receives order information from the viewer side via the communication medium and sends restrictive reception information to the viewer side over the communication medium, and settling means performs processing of charging the viewer side. In the viewer side, receiving means receives a contents delivery stream containing the information fragments and the article/advertisement correspondence information, sending and receiving means sends the order information to the supply side over the communication medium and receives the restrictive reception information from the supply side via the communication medium, and information fragments receiving means captures information fragments that conform to instructions and information fragments that are correlated with the information fragments that conform to the instructions from the contents delivery stream based on the restrictive reception information and the article/advertisement correspondence information. Therefore, the supply side can freely correlate articles with advertisements. When the correspondence between articles and advertisement needs to be altered, the only measure to be taken is to alter the contents of article/advertisement correspondence information. Further, settlement processing is simplified because it is performed based on order information that is received via the communication medium.

On the other hand, the viewer side need not pay for a cost of transmitting information fragments and article/advertisement correspondence information. Since information reaches the viewer side immediately, latest information can be supplied to the user side. The viewer side can acquire constantly updated information. Further, unlike the case of printed publications, paper is not consumed wastefully. Still further, since the viewer side can make a subscription contract by freely specifying a desired genre, a period, etc. via the communication medium, the degree of freedom of contract is increased.

Further, in capturing articles or advertisements based on restrictive reception information, an advertisement that is correlated with an article in advance or an article that is correlated with an advertisement in advance is captured based on article/advertisement correspondence information, which makes it possible to simultaneously display the article and the advertisement correlated with it or the advertisement and the article correlated with it.

Each of the above information exchange systems may be such that, in the supply side, the delivering means sends the information fragments after coding those, and the sending and receiving means causes the restrictive reception information to include decoding information, and that, in the viewer side, the information fragments receiving means decodes captured information fragments based on the decoding information. In this case, a content delivery stream whose safety is secured by coding and decoding can be received in a restricted manner.

Each of the above information exchange system may be such that the sending and receiving means in the supply side sends control information to be used for causing the information fragments receiving means to capture only information fragments that conform to the instructions or only the information fragments that conform to the instructions and information fragments that are correlated with the information fragments that conform to the instructions, and that the viewer side captures only information fragments that conform to the instructions or only the information fragments that conform to the instructions and information fragments that are correlated with the information fragments that conform to the instructions from the contents delivery stream based on the control information. In this case, a content delivery stream whose safety is secured by a simplified apparatus configuration that does not employ coding and decoding can be received in a restricted manner. In particular, restrictive reception of only articles and advertisements correlated with those is realized.

What is claimed is:

1. A business model for providing articles and advertisements for pay by contents delivery in which articles or contents are delivered to a viewer side over a contents delivery medium and bidirectional information exchange is performed with the viewer side over a communication medium, comprising the steps of:
converting articles or advertisements into information fragments of various genres, and coding and delivering at least part of the information fragments of each genre;
making, with the viewer side, a chargeable provision contract having contract conditions including an arbitrary genre of information fragments to be provided to the viewer side for pay and an arbitrary effective period; and
after making the chargeable provision contract, giving the viewer side, via the communication medium, a restrictive reception control signal to be used for decoding only information fragments that satisfy the contract conditions.

2. An information exchange method using a contents delivery system in which a supply-side information exchange apparatus supplies information contents to a viewer-side information exchange apparatus over a wireless or wired contents delivery medium and information exchange is performed over a bidirectional communication medium that connects the supply-side information exchange apparatus and the viewer-side information exchange apparatus, wherein information contents to be delivered include at least one of article contents and advertisement contents, the information exchange method comprising:
a first step, executed by the supply-side information exchange apparatus, of drawing up information fragments by adding a mark including genre information indicating a genre to each of the information contents, and broadcasting a contents delivery stream containing the information fragments to the viewer-side information exchange apparatus;
a second step, executed by the viewer-side information exchange apparatus, of sending, to the supply-side information exchange apparatus, over the communication medium, order/selection information indicating at least a subscription-desired genre and a subscription period;
a third step, executed by the supply-side information exchange apparatus, of sending, to the viewer-side information exchange apparatus, over the communication medium, restrictive reception information to be used for allowing capture of information fragments that satisfy conditions of the order/selection information;
a fourth step, executed by settling means of the supply-side information exchange apparatus, of performing processing of charging the viewer-side information exchange apparatus based on the conditions of the order/selection information; and
a fifth step, executed by the viewer side information exchange apparatus, of capturing information fragments that satisfy the conditions from the contents delivery stream received in the subscription period based on the restrictive reception information received.

3. An information exchange method using a contents delivery system in which a supply-side information exchange apparatus supplies information contents to a viewer-side information exchange apparatus over a wireless or wired contents delivery medium and information exchange is performed over a bidirectional communication medium that connects the supply-side information exchange apparatus and the viewer-side information exchange apparatus, wherein information contents to be delivered include at least one of article contents and advertisement contents, the information exchange method comprising:
a first step, executed by the supply-side information exchange apparatus, of drawing up information fragments by adding a mark including genre information indicating a genre to each of the information contents, generating article/advertisement correspondence information that correlates information fragments of the article contents with information fragments of the advertisement contents, and broadcasting a contents delivery stream containing the information fragments and the article/advertisement correspondence information to the viewer-side information exchange apparatus;
a second step, executed by the viewer-side information exchange apparatus, of sending, to the supply-side information exchange apparatus, over the communication medium, order/selection information indicating at least a subscription-desired genre and a subscription period;
a third step, executed by the supply-side information exchange apparatus, of sending, to the viewer-side information exchange apparatus, over the communication medium, restrictive reception information to be used for allowing capture of information fragments that satisfy conditions of the order/selection information;
a fourth step, executed by settling means of the supply-side information exchange apparatus, of performing processing of charging the viewer-side information exchange apparatus based on the conditions of the order/selection information; and
a fifth step, executed by the viewer side information exchange apparatus, of capturing information fragments that satisfy the conditions and information fragments that are correlated with the information fragments that satisfy the conditions by the article/advertisement correspondence information from the contents delivery stream received in the subscription period based on the restrictive reception information received.

4. The information exchange method according to claim 2 or 3, wherein:
the first step sends the contents delivery stream to the viewer-side information exchange apparatus after coding at least the information fragments;
the third step causes the restrictive reception information to include decoding information to be used for decoding at least coded information fragments; and
the fifth step decodes captured coded information fragments based on the decoding information received.

5. The information exchange method according to claim 2 or 3, wherein:
the third step causes the restrictive reception information to include control information to be used for causing the viewer-side information exchange apparatus to capture only information fragments that satisfy the conditions or only the information fragments that satisfy the conditions and information fragments that are correlated with the information fragments that satisfy the conditions in the subscription period; and
the fifth step captures only information fragments that satisfy the conditions or only the information fragments that satisfy the conditions and information fragments that are correlated with the information fragments that satisfy the conditions from the contents delivery stream in the subscription period based on the control information received.

6. An information exchange system in which a supply-side information exchange apparatus supplies information contents to a viewer-side information exchange apparatus over a wireless or wired contents delivery medium and information exchange is performed over a bidirectional communication medium that connects the supply-side information exchange apparatus and the viewer-side information exchange apparatus, wherein:
information contents to be delivered include at least one of article contents and advertisement contents;
the supply-side information exchange apparatus comprises:
drawing-up means for drawing up information fragments by adding a mark including genre information indicating a genre to each of the information contents;
delivering means for delivering a contents delivery stream containing the information fragments to the viewer-side information exchange apparatus;
supply-side sending and receiving means for receiving, via the communication medium, order information indicating subscription conditions that is sent from the viewer-side information exchange apparatus, and for sending, to the viewer-side information exchange apparatus, over the communication medium, restrictive reception information to be used for allowing capture of information fragments that conform to the order information; and
settling means for performing processing of charging the viewer-side information exchange apparatus based on the subscription conditions; and
the viewer-side information exchange apparatus comprises:
viewer-side sending and receiving means for sending the order information indicating, as the subscription conditions, at least a subscription-desired genre and a subscription period to the supply-side information exchange apparatus over the communication medium, and for receiving the restrictive reception information from the supply-side information exchange apparatus via the communication medium; and
information fragments receiving means for capturing information fragments that satisfy the subscription conditions from the contents delivery stream received in the subscription period based on the received restrictive reception information.

7. An information exchange system in which a supply-side information exchange apparatus supplies information contents to a viewer-side information exchange apparatus over a wireless or wired contents delivery medium and information exchange is performed over a bidirectional communication medium that connects the supply-side information exchange apparatus and the viewer-side information exchange apparatus, wherein:
information contents to be delivered include at least one of article contents and advertisement contents;
the supply-side information exchange apparatus comprises:
drawing-up means for drawing up information fragments by adding a mark including genre information indicating a genre to each of the information contents;
article/advertisement correlating means for generating article/advertisement correspondence information that correlates information fragments of the article contents with information fragments of the advertisement contents;
delivering means for delivering a contents delivery stream containing the information fragments and the article/advertisement correspondence information to the viewer-side information exchange apparatus;
supply-side sending and receiving means for receiving, via the communication medium, order information indicating subscription conditions that is sent from the viewer-side information exchange apparatus, and for sending, to the viewer-side information exchange apparatus, over the communication medium, restrictive reception information to be used for allowing capture of information fragments that conform to the order information; and
settling means for performing processing of charging the viewer-side information exchange apparatus based on the subscription conditions; and
the viewer-side information exchange apparatus comprises:
receiving means for receiving the contents delivery stream containing the information fragments and the article/advertisement correspondence information;
viewer-side sending and receiving means for sending the order information indicating, as the subscription conditions, at least a subscription-desired genre and a subscription period to the supply-side information exchange apparatus over the communication medium, and for receiving the restrictive reception information from the supply-side information exchange apparatus via the communication medium; and
information fragments receiving means for capturing information fragments that satisfy the subscription conditions and information fragments that are correlated with the information fragments that satisfy the subscription conditions by the article/advertisement correspondence information from the received contents delivery stream in the subscription period based on the received restrictive reception information and article/advertisement correspondence information.

8. The information exchange system according to claim 6 or 7, wherein:
the delivering means sends the contents delivery stream to the viewer-side information exchange apparatus after coding at least the information fragments;
the supply-side sending and receiving means causes the restrictive reception information to include decoding information to be used for decoding at least coded information fragments; and
the information fragments receiving means decodes captured coded information fragments based on the decoding information received.

9. The information exchange system according to claim 6 or 7, wherein:
the supply-side sending and receiving means causes the restrictive reception information to include control information to be used for causing the information fragments receiving means to capture only information fragments that satisfy the subscription conditions or only the information fragments that satisfy the subscription conditions and information fragments that are correlated with the information fragments that satisfy the subscription conditions in the subscription period; and
the information fragments receiving means captures only information fragments that satisfy the subscription conditions or only the information fragments that satisfy the subscription conditions and information fragments that are correlated with the information fragments that satisfy the subscription conditions from the contents delivery stream in the subscription period based on the control information received.
